(19) United States
(12) Patent Application Publication
(10) Pub. No.: US 2023/0062764 A1
(43) Pub. Date: Mar. 2, 2023

(54) METHOD, SYSTEM AND COMPUTER PROGRAM PRODUCTS FOR MANAGEMENT OF SUPPLY CHAINS AND/OR INVENTORY FOR PERISHABLE GOODS

(71) Applicant: FRESHPOINT QUALITY ASSURANCE LTD., Nesher (IL)

(72) Inventor: Husein SALMAN, Ghajar Village (IL)

(21) Appl. No.: 17/760,413

(22) PCT Filed: Apr. 19, 2021
(86) PCT No.: PCT/IL2021/050443

§ 371 Date: Aug. 9, 2022

(30) Foreign Application Priority Data
Apr. 20, 2020 (IL) 274060

(51) Int. Cl. G06Q 10/08; G01K 11/12; G01K 3/04

(52) U.S. Cl. CPC G06Q 10/0832; G06Q 10/087; G01K 11/12; G01K 3/04

(57) ABSTRACT

A method for management of perishable goods handling, including using a hardware processor for reading and/or recognition and/or monitoring at least one of color change, appearance/disappearance of at least a segment, variation in at least one of pattern, shape and/or size of at least a portion of an indication window of at least one TTI affixed to at least one item of perishable goods, thereby to obtain a TTI reading, and for processing that reading including generating and outputting at least one perishable goods handling command, responsive to at least the TTI reading.

### REFERENCE TO CO-PENDING APPLICATIONS

Priority is claimed from Israeli Patent Application No. 274060 entitled “Method, system and computer program products for management of supply chains and/or inventory for perishable goods” and filed 20 Apr. 2020, the disclosure of which application is hereby incorporated by reference.

### FIELD OF THIS DISCLOSURE

The present invention relates generally to management of perishable goods and more particularly to Time Temperature Indicators (TTIs).

### BACKGROUND FOR THIS DISCLOSURE

Conventional technology, constituting background to certain embodiments of the present invention, is described in the following publications inter alia:
Jiangbo Li, Xiuqin Rao, Yibin Ying, Zhenyu Zhang, 2010 ASABE Annual International Meeting, Pittsburgh, Pa. Jun. 20-Jun. 23, 2010;
M. Z. Abdullah, J. Mohamad-Saleh, A. S. Fathinul-Syahir, B. M. N. Mohd-Azemi, Journal of Food Engineering 76 (2006) 506-523. b) Maciej Zaborowicz, Piotr Boniecki, Krzysztof Koszela, Andrzej Przybylak, Jacek Przybył, Scientia Horticulturae 218 (2017) 222-229. c) Ajay Pal Singh Chauhan, Amar Partap Singh, International Journal of Computer Applications (0975-8887), 60, 2012;
Elena V. Gorbunova, Aleksandr N. Chertov, Daria B. Petukhova, Artem A. Alekhin, Valery V. Korotaev, Proc. SPIE 9369, Photonic Instrumentation Engineering II, 93690Z (13 Mar. 2015); doi:10.1117/12.2081664;
Hanmei Hong, Xiaoling Yang, Zhaohong You, Fang Cheng, Aquacultural Engineering 63 (2014) 62-71. b) Majid Dowlati a, b, Seyed Saeid Mohtasebi a, Mahmoud Omid a, Seyed Hadi Razavi c, Mansour Jamzad d, Miguel de la Guardia, Journal of Food Engineering 119 (2013) 277-287. c) V. M. Ocaño-Higuera, A. N. Maeda-Martínez, E. Marquez-Ríos, D. F. Canizales-Rodríguez, F. J. Castillo-Yáñez, E. Ruíz-Bustos, A. Z. Graciano-Verdugo, M. Plascencia-Jatomea, Food Chemistry 125 (2011) 49-54.

Evigence Sensors® Time Temperature Indicators (TTI) are commercially available sensors, based on aluminum etching technology, registering cumulative time-temperature exposure of perishable goods to which they are attached. The sensors are assembled from a base label (printed aluminized label) and a printed active label that contains an etchant in its adhesive layer. In some embodiments, once the active label is placed on top of the base label, the TTI is activated, and the etching process starts. This process is time and temperature dependent, creating a visual change of the indicator. In other embodiments, the TTI is assembled and put at low temperatures to relent or stop the etching process until activated by placing the TTI in its working temperature range.

An example TTI is described in the following patent document: http://www.freepatentsonline.com/y2010/0296545.html.

The following patent document https://patents.google.com/patent/US20070076779A1/en?assignee=freshpoint describes a device for controlling quality of a perishable object, while progressing on its supply line, by monitoring the condition of a time-temperature indicator (TTI). The device comprises a sensing assembly for detecting a response of the TTI to a predetermined stimulus, and generating measured data representative thereof, which is indicative of the condition of the TTI, thereby enabling determination of the remaining shelf life of perishable goods to which the TTI is attached and calibrated.

This link: https://thespoon.tech/cool-idea-varcode-uses-blockchain-and-barcodes-to-monitor-the-food-supply-cold-chain/ describes that “Distributors and buyers want to make sure the food they purchase has stayed at the proper temperature . . . . Varcode creates barcode stickers that have a built-in temperature sensors that continuously keep track of the ambient temperature those goods are stored in . . . . Varcodes can be scanned with a regular handheld scanner or a mobile phone, and each link (distributor, transpiration, etc.) in the cold chain scans the Varcode when they receive a box and when they hand it off . . . . If food gets too warm at any point, Varcode's system will show exactly when it happened. It's costs $2 per tag . . . . There are . . . preset tags for . . . seafood and berries, or customers can create their own customized tags”.

The disclosures of all publications and patent documents mentioned in the specification, and of the publications and patent documents cited therein directly or indirectly, are hereby incorporated by reference, other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF CERTAIN EMBODIMENTS

Certain embodiments of the present invention seek to provide a method, system and computer program products for supply chain management and/or inventory management of perishable goods.

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, or any combination thereof, as appropriate.

Certain embodiments of the present invention seek to quantify a color change of the active area of TTI sensors, not by a human's qualitative impression, but instead using equipment for measuring color parameters or reflective optical density of the active area over time.

It is appreciated that any reference herein to, or recitation of, an operation being performed is, e.g. if the operation is performed at least partly in software, intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operations and, instead, the remote processor P itself may receive output/s of portion/s of the operation from yet another processor/s P′, may be deployed off-shore relative to P, or “on a cloud”, and so forth.

Thus, the present invention typically includes at least part of the following embodiments:

Embodiment 1. A method for management of perishable goods handling, including using a hardware processor for reading at least one TTI typically affixed to at least one item of perishable goods, thereby to obtain a TTI reading, and/or for processing the reading including generating and/or outputting at least one perishable goods handling command, responsive to at least the TTI reading.

Embodiment 2. The method of any of the preceding embodiments wherein the handling comprises management of at least part of a perishable goods supply chain.

Embodiment 3. The method of any of the preceding embodiments and wherein at least one command comprises scheduling an inspection of a portion of the supply chain and/or issuing a warning message.

Embodiment 4. The method of any of the preceding embodiments wherein the method comprises storing knowledge regarding expected progress of TTIs between supply chain nodes, monitoring actual progress of TTIs between supply chain nodes and wherein at least one command is issued when the actual progress is faster or slower than the expected progress.

Embodiment 5. The method of any of the preceding embodiments wherein outputting of at least one perishable goods handling command, is responsive also to data other than the TTI reading.

Embodiment 6. The method of any of the preceding embodiments wherein the data comprises location of acquired data (e.g. GPS).

Embodiment 7. The method of any of the preceding embodiments wherein the reading comprises registration and/or translation of an acquired image of the TTI.

Embodiment 8. The method of any of the preceding embodiments wherein the reading comprises pre-processing and/or filtering of an image, either segmented or non-segmented, of the TTI.

Embodiment 9. The method of any of the preceding embodiments wherein the reading comprises extracting at least one feature from image data derived from the TTI and using a Machine-learning based model which receives the at least one feature as input.

Embodiment 10. The method of any of the preceding embodiments wherein the model comprises a regression model.

Embodiment 11. The method of any of the preceding embodiments wherein the regression model comprises a knn regression model.

Embodiment 12. The method of any of the preceding embodiments wherein the method comprises Barcode reading.

Embodiment 13. The method of any of the preceding embodiments and also comprising using Measurement validity & accuracy estimators to reject poor quality images of the TTI.

Embodiment 14. The method of any of the preceding embodiments and

wherein a conversion model converts color measurement derived from the TTI, to an output parameter such as but not limited to remaining shelf life at a given temperature or an indication of whether or not the product's quality and/or freshness is optimal.

Embodiment 15. The method of any of the preceding embodiments wherein the method includes validating that at least one key connected component appears in an image of the TTI and otherwise, providing a command, in at least near real-time, to re-align a camera thereby to allow imaging of the TTI to be repeated timely, when necessary.

Embodiment 16. A system comprising at least one hardware processor configured to carry out the operations of the method of any of the preceding embodiments.

Embodiment 17. A system for management of a perishable goods supply chain which comprises plural nodes, the system including using a hardware processor for reading at least one sensor affixed to at least one item of perishable goods and/or to at least one of the plural nodes, wherein the system is operative to provide all or any subset of the following functionalities:
a. Product identification;
b. Assessment of remaining shelf-life;
c. Decision making on controlling the supply chain;
d. Decision making on improvements in the supply chain;
e. Assessment of client response;
f. Optimization or adjustment of product price;
g. Facilitating compliance with regulations, standards, and laws;
h. management of inventory and/or supply chains for perishable goods, based at least on determining whether TTI progress between supply chain nodes is faster or slower than expected or as expected.
i. enabling decision making
j. raising flags
k. generating recommendations

Embodiment 18. The system of any one of the preceding embodiments 16-17 which uses System statistical performance evaluation tools for monitoring system performance.

Embodiment 19. The system of any one of the preceding embodiments 16-17 which uses System statistical performance evaluation tools for generating at least one command to acquire at least one new image to be included in a training set for re-training a model used by the system,

Embodiment 20. The system of any one of the preceding embodiments 16-17 which uses System statistical performance evaluation tools for selecting at least one already acquired image to be included as a training set for re-training a model used by the system.

Embodiment 21. The system of any one of the preceding embodiments wherein the command is provided via an API to a computerized inventory control system.

Embodiment 22. The system of any one of the preceding embodiments wherein the command is provided via an API to a computerized supply chain management system.

Embodiment 23. The system of any one of the preceding embodiments wherein the command is presented to a human end-user of the system via an interface.

Embodiment 24. The system of any one of the preceding embodiments and also comprising a first interface for retail customers and/or a second interface for nodes along the supply chain other than customers.

Embodiment 25. The system of any one of the preceding embodiments wherein cameras are interconnected through a central CPU that compensates for camera and lighting characteristics at which the perishable goods are imaged.

Embodiment 26. The method of any of the preceding embodiments wherein the suspect portion is identified at least partly by monitoring TTI readings associated with the supply chain portion (node/s and/or link/s).

Embodiment 27. The method of any of the preceding embodiments wherein the suspect portion is identified at least partly by monitoring human behavior associated with the supply chain portion (node/s and/or link/s).

Embodiment 28. The method of any of the preceding embodiments wherein the TTI readings typically have reduced safety margins which do not compensate for at least one ambient condition known to fluctuate and wherein the ambient condition is measured directly, thereby to yield at least one direct ambient condition measurement and wherein at least one command is issued responsive to the TTI readings and to the at least one direct measurement.

Embodiment 29. A computer program product, comprising a non-transitory tangible computer readable medium having computer readable program code embodied therein, the computer readable program code adapted to be executed to implement a method for management of perishable goods handling, including using a hardware processor for reading at least one TTI affixed to at least one item of perishable goods, thereby to obtain a TTI reading, and for outputting at least one perishable goods handling command, responsive to at least the TTI reading.

Embodiment 30. The method of any of the preceding embodiments wherein the handling comprises control of perishable goods inventory and wherein the at least one command typically includes at least one command to use certain perishable goods items in an order other than FIFO order.

Also provided, excluding signals, is a computer program comprising computer program code means for performing any of the methods shown and described herein when said program is run on at least one computer; and a computer program product, comprising a typically non-transitory computer-usable or -readable medium e.g. non-transitory computer-usable or -readable storage medium, typically tangible, having a computer readable program code embodied therein, said computer readable program code adapted to be executed to implement any or all of the methods shown and described herein. The operations in accordance with the teachings herein may be performed by at least one computer specially constructed for the desired purposes, or a general-purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules illustrated and described herein may include any one or combination or plurality of: a server, a data processor, a memory/computer storage, a communication interface (wireless (e.g. BLE) or wired (e.g. USB)), and a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. Use of nouns in singular form is not intended to be limiting; thus, the term processor is intended to include a plurality of processing units which may be distributed or remote, the term server is intended to include plural typically interconnected modules running on plural respective servers, and so forth.

The above devices may communicate via any wired or wireless digital communication means, e.g. via a wired or cellular telephone network, or a computer network such as the Internet.

The apparatus of the present invention may include, according to certain embodiments of the invention, machine readable memory containing or otherwise storing a program of instructions which, when executed by the machine, implements all or any subset of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices or may be provided to external factors e.g. via a suitable data network. The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g. chips, which may be co-located or remote from one another. Any controller or processor may for example comprise at least one CPU, DSP, FPGA or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs) or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to, a sensor, may be used to generate or otherwise provide information received by the apparatus and methods shown and described herein. Any suitable output device or display may be used to display, or output information generated by the apparatus and methods shown and described herein. Any suitable processor/s may be employed to compute or generate information as described herein and/or to perform functionalities described herein and/or to implement any engine, interface or other system illustrated or described herein. Any suitable computerized data storage e.g. computer memory may be used to store information received by or generated by the systems shown and described herein. Functionalities shown and described herein may be divided between a server computer and a plurality of client computers. These or any other computerized components shown and described herein, may communicate between themselves via a suitable computer network.

The system shown and described herein may include user interface/s e.g. as described herein which may for example include all or any subset of: an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus the term user interface or “UI” as used herein, includes also the underlying logic which controls the data presented to the user e.g. by the system display and receives and processes and/or provides to other modules herein, data entered by a user e.g. using her or his workstation/device.

### BRIEF DESCRIPTION OF THE DRAWINGS

Example embodiments are illustrated in the various drawings. Specifically:

FIG. 1 is a block diagram of the main functional elements and nodes of a supply chain of perishable goods, according to some embodiments of the invention;

FIG. 2 illustrates a first general aka coalesced type of appearance or presentation or physical arrangement of the goods at a node of the supply chain, according to some embodiments of the invention;

FIG. 3 illustrates a second general aka spread type of appearance or presentation or physical arrangement of the goods at a node of the supply chain, according to some embodiments of the invention;

FIG. 4 illustrates a perishable product with sensing devices attached to it, according to some embodiments of the invention;

FIG. 5 illustrates one general type of data acquisition station for reading information from the goods and their associated sensing devices of goods in their coalesced state at a node of the supply chain, according to some embodiments of the invention;

FIG. 6 illustrates one general type of data acquisition station for reading information from the goods and their associated sensing devices of goods in their spread state at a node of the supply chain, according to some embodiments of the invention;

FIG. 7 is a block diagram describing an example method operative to combine and process acquired information in the information processing unit (this term is intended herein to include a hardware processor), make decisions based on information, and execute decisions made, according to some embodiments of the invention.

FIG. 8 is a simplified flowchart illustration of a TTI reading method provided in accordance with certain embodiments; all or any subset of the illustrated operations may be provided, in any suitable order e.g. as shown.

FIG. 9 is a bar chart useful in understanding certain embodiments.

FIGS. 10a, 10b are simplified pictorial illustrations of an example TTI.

FIG. 11 is a simplified pictorial illustration of mask/s.

FIG. 12 is a graph illustration useful in understanding certain embodiments; the graph shows a linear fit using a “theoretical” reference value of the indication parameter against measured values of the indication parameter, for example, component a*, indicating the scale of green to red in the L*a*b* color space, where the Y axis is the known calibration value, and in the X axis are, as measured, say on a 1->256 scale; the linear fit may then be used to convert values e.g. as described herein.

Certain embodiments of the present invention are illustrated in the following drawings; in the block diagrams, arrows between modules may be implemented as APIs aka application program interfaces and any suitable technology may be used for interconnecting functional components or modules illustrated herein in a suitable sequence or order, e.g. via a suitable API/Interface. For example, state of the art tools may be employed, such as but not limited to Apache Thrift and Avro, which provide remote call support. Or, a standard communication protocol may be employed, such as but not limited to HTTP or MQTT, and may be combined with a standard data format, such as but not limited to JSON or XML.

Methods and systems included in the scope of the present invention may include any subset or all of the functional blocks shown in the specifically illustrated implementations by way of example, in any suitable order e.g. as shown. Flows may include all or any subset of the illustrated operations, suitably ordered e.g. as shown. Tables herein may include all or any subset of the fields and/or records and/or cells and/or rows and/or columns described.

Computational, functional or logical components described and illustrated herein can be implemented in various forms, for example, as hardware circuits, such as but not limited to custom VLSI circuits or gate arrays or programmable hardware devices, such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave, or act as described herein with reference to the functional component in question. For example, the component may be distributed over several code sequences, such as but not limited to objects, procedures, functions, routines and programs, and may originate from several computer files which typically operate synergistically.

Each functionality or method herein may be implemented in software (e.g. for execution on suitable processing hardware such as a microprocessor or digital signal processor), firmware, hardware (using any conventional hardware technology such as Integrated Circuit technology) or any combination thereof.

Functionality or operations stipulated as being software-implemented may, alternatively, be wholly or fully implemented by an equivalent hardware or firmware module and vice-versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware, in which case all or any subset of the variables, parameters, and computations described herein may be in hardware.

Any module or functionality described herein may comprise a suitably configured hardware component or circuitry. Alternatively, or in addition, modules or functionality described herein may be performed by a general-purpose computer or more generally by a suitable microprocessor, configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option, such as but not limited to FPGA, ASIC or DSP or any suitable combination thereof.

Any hardware component mentioned herein may in fact include either one or more hardware devices, e.g. chips, which may be co-located or remote from one another.

Any method described herein is intended to include within the scope of the embodiments of the present invention also any software or computer program performing all or any subset of the method's operations, including a mobile application, platform or operating system e.g. as stored in a medium, as well as combining the computer program with a hardware device to perform all or any subset of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus, which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

Elements illustrated in more than one drawings, and/or elements in the written description may still be combined into a single embodiment, except if otherwise specifically clarified herewithin.

### DETAILED DESCRIPTION OF CERTAIN EMBODIMENTS

Efficient management of inventories and/or supply chains of perishable goods often require real time knowledge of the location, condition, as well as the history of a large number of items. Amongst the key determinants of efficiency of such supply chains is the ability to accurately determine or assess the “freshness” (which here and after, is intended to include a product state rendering the product acceptable for use in terms of organoleptic, microbial and other food safety and/or food quality considerations and/or regulations) condition and/or remaining shelf-life, and/or remaining regulatory shelf-life, and/or time before expiry, of items, in order to minimize loss and maximize client and/or regulator satisfaction. Certain embodiments include a method, system and computer program products for effective management of supply chains and/or inventory of perishable goods including typically holistic and quantitative assessment of the condition (e.g. freshness condition) and/or location of the different items along the supply chain, and/or facilitating tracking of items, and/or regulation enforcement, and/or effective decision making. It should be noted that while supply chains of perishable goods extend the entire way from production of raw materials to consumption by the end user, the method system and computer program products for supply chain management of perishable goods disclosed therein may apply to any portion/s or node/s or link/s of the supply chain, as well as to all of it, from production to consumption nodes.

Certain embodiments include management of supply chains and/or inventory of perishable goods using real-time acquisition of information from the goods and sensors capable of reporting properties of the goods, using different reading techniques. In accordance with certain embodiments, raw data is acquired from the goods, as well as from sensors capable of reporting properties and information disclosing devices, such as, but not limited to, 1D and 2D barcodes, RF-ID tags, GPS locators, relative humidity sensors, thermometers, time-temperature indicators (TTIs), threshold indicators (TIs), volatile gas (such as for example amines and thiols) sensors, authentication indicators and the like, which may use any suitable communication technology, thereby to yield raw data. This raw data may then be processed using any suitable data processing techniques, such as but not limited to pattern recognition, differential pattern recognition, color analysis, differential color analysis, time-based location, for example based on GPS signal, barcode reading and the like, and added to a database. GUI offers a reliable real-time status report of the entire chain components, including rank selective and/or person selective and/or user adjustable information, and, typically, a way of presenting it.

The system may include all or any subset of the following components:
1) At least one of at least one type of information reader, such as:
   a. An electromagnetic radiation reader, such as RF-ID reader and/or photodetector.
   b. An imaging device, such as a camera and/or scanner.
   c. Global Positioning System (GPS) signal reader; throughout GPS is used as an example of a subsystem for localizing e.g. an item within a node, or a node within a supply chain.
2) At least one of at least one type of sensing devices, attached (herein, “attached” aka “operatively associated” refers to being coupled with and/or bound to and/or being in data communication with and/or being located relative to, an item, so as to enable that item to be sensed by that device) to at least one item e.g. an item of perishable goods, such as:
   a. A time-temperature indicating device (TTI)
   b. A threshold temperature indicating device and/or a freeze and time indicator (TI)
   c. A gas sensor
   d. A humidity sensor
   e. A temperature sensor
   f. A particle sensor
   g. Image and/or color capturing device, such as a camera.
3) Optionally, at least one of at least one type of information carrying devices, attached to at least one item, such as:
   a. 1D and/or 2D and/or 3D barcode and the like
   b. RF-ID tag and the like
   c. Reflected and/or emitted color, logo, signage, graphical signs, pictures, films, emoji, writing, voice, words and the like.
   d. Location of item in space. An item (references to “item” herein are all intended to include items of perishable goods inter alia, such as a vegetable or other item of fresh produce, such as a bag, or basket, or box, or other container of fresh produce).
4) At least one of at least one type of information processing unit.
5) At least one of at least one type of information presenting device, such as a screen.

The system may also include any item and device that facilitates generation and processing of, and decision making based on said information, such as light sources, color reference scales, timers, time readers and the like.

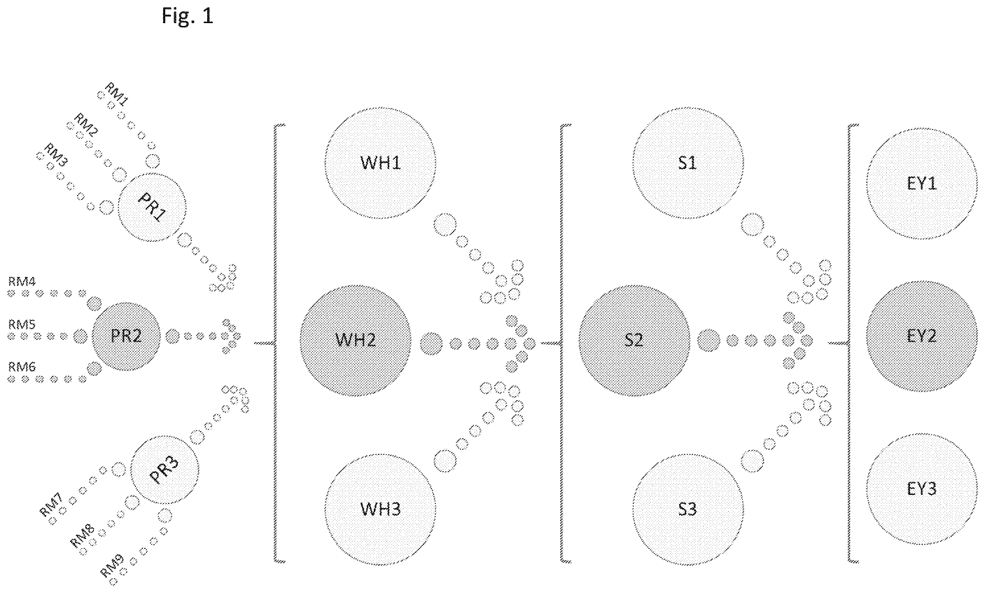

FIG. 1 illustrates, by way of a simplified block diagram, functional elements and nodes of an exemplary supply chain of perishable goods, according to some embodiments of the invention.

Supply chains extend the entire way from raw materials, RM1-RM9, through transportation (denoted in FIG. 1 by dotted arrows) production, PR1-PR3, warehouses or distribution centers, WH1-WH3, shops or restaurants, S1-S3, and other supply chain nodes, to storage, processing and consumption by the end user, EY1, EY2, EY3. In some cases, in order to have effective management of the supply chain, there may be a need to acquire information from all its nodes. In other cases, such as for example the management of the refrigerator of an end-user, it is enough to limit data acquisition to selected nodes. As may be appreciated from FIG. 1, the supply chain may contain varying numbers of nodes, and have different complexity, depending on the product and on management interests.

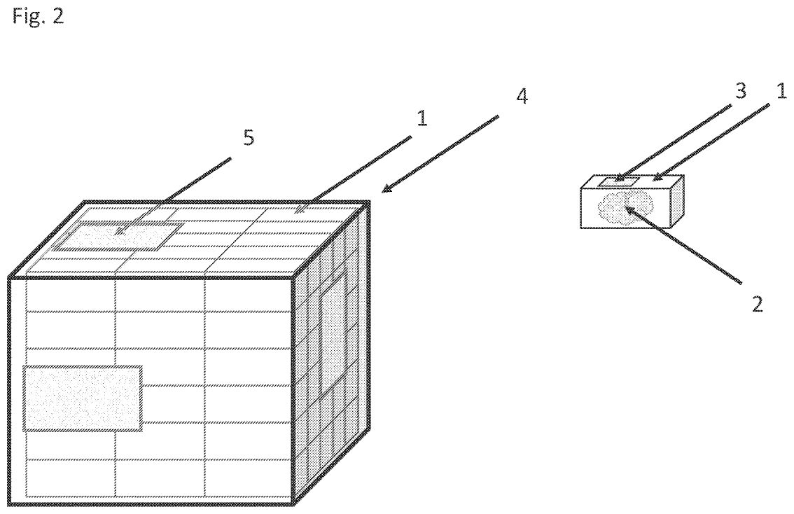

FIG. 2 presents schematically one general coalesced type of appearance of the goods at a node of the supply chain, according to some embodiments of the invention; in this embodiment said coalesced type of appearance of the goods is in the form of a multiple unit package, a box of packages, a pallet of packages, a stack of packages which may be ordered or randomly stacked and the like, 1, containing the perishable product, 2, and optionally bearing on it any one or more of the following: information, in the form of electronic information stored for example in a data logger that is connected to one or more sensors that sample and store data in it, writing, logo, emojis, barcodes, pictures, varying pictures, vocal information, color changing information and the like, as well as sensors, such as gas (such as for example amines and/or thiols and/or CO₂) sensors, time-temperature sensors, threshold temperature sensors, temperature sensors, pH sensors, relative humidity sensors and the like, 3. The individual packages are packed in a larger package, 4, containing a plurality of individual packages, 1. Package 4 may optionally bear on it any one or more of the following: information, in the form of electronic information stored for example in a data logger that is connected to one or more sensors that sample and store data in it, writing, logo, emojis, barcodes, pictures, varying pictures, vocal information, color changing information and the like, as well as sensors, such as gas (such as for example amines and/or thiols and/or CO₂) sensors, time-temperature sensors, temperature sensors, pH sensors, relative humidity sensors and the like, 5. In some embodiments of the present invention at least one of the individual packages, 1, and/or its content, 2, and/or at least one of its associated information and/or sensors, is visible through package 4, while in other cases it is not visible.

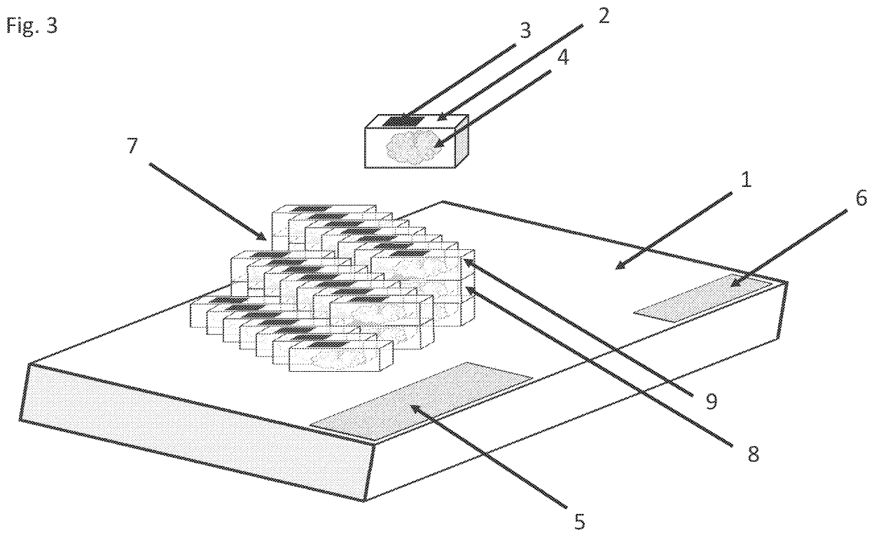

FIG. 3 illustrates a second general spread type of appearance of the goods at a node of the supply chain, according to some embodiments of the invention. In some nodes the supply chain's preferred and/or desired method is to spread the individual packages. For example, the individual packages, 2, optionally bearing on them any one or more of the following: information, in the form of electronic information stored for example in a data logger that is connected to one or more sensors that sample and store data in it, writing, logo, emojis, barcodes, pictures, varying pictures, vocal information, color changing information and the like, as well as sensors, such as gas (such as for example amines and/or thiols and/or CO₂) sensors, time-temperature sensors, threshold temperature sensors, temperature sensors, pH sensors, relative humidity sensors and the like, 3, and containing the perishable goods, may be placed on a shelf, 1, for example of a refrigerator, in a store. In the vicinity of the shelf there may be optionally any one or more of the following: information, 5, in the form of electronic information stored for example in a data logger that is connected to one or more sensors that sample and store data in it, writing, logo, emojis, barcodes, pictures, varying pictures, vocal information, color scale, color changing information and the like, as well as sensors, 6, such as gas (such as for example amines and/or thiols and/or CO₂) sensors, time-temperature sensors, threshold temperature sensors which may include thaw and/or freezer indicators, temperature sensors, pH sensors, relative humidity sensors, radiation sensors, Micro wave sensors, UV sensors, infrared sensors, and the like. The individual packages may be hidden (the term “hidden” herein refers to being inaccessible to human and/or machine readers, herein, machine reader refers to a machine capable of receiving input that contains useful information, such as visual, vocal, barcode (optical and/or other) and the like), 7, for example under other packages, or partially hidden, 8, for example with the product partially exposed (the term “partially exposed” herein refers to cases in which at least part of the information is accessible to human and/or machine readers), and/or said information is partially exposed and/or said sensors are partially exposed. The individual package may also be fully accessible (the term “fully accessible” herein refers to cases in which all the information is fully accessible to human and/or machine readers), 9.

Typically, when goods are coalesced, the goods are aggregated, or even packaged together, e.g. in orderly stack/s, or in an unordered pile. An aggregated group of items, in which some of the items at least partially obscure others, is termed herein a “stack”, for simplicity.

Typically, in some cases, some of the surface area of spread items are visible, which is not the case for coalesced goods, all or the majority of which may not be visible or may only be partially visible.

Typically, transportation and storage of most products is in coalesced form, whereas selling points spread the products. The terms coalesced and spread define the two extreme cases and many embodiments may also refer to or distinguish or identify or separately handle mixtures of coalesced and spread cases in at least one of their nodes.

For either spread or coalesced goods, identification of goods type may be achieved by collecting data, including OCR, of any suitable texts e.g. labels on the goods, identification of logo, and barcode reading. Identification of individual packages may be done with all the above, using specific barcodes, as well as any uniqueness of package, including specific appearance of the specific product, visual defects, or any other uniqueness in the package and alike.

When goods are coalesced, identification of the goods and their characteristics is more difficult, due to one item of perishable goods obscuring another. However, according to certain embodiments, the system is configured to read whatever is available in terms of TTI information and/or appearance of product, as a function of time and temperature, and use this to generate a database for further use in future assessments. All, or any subset of sensors on each package or item of perishable goods, may be read.

According to certain embodiments, collective decisions may be made for goods in a stack—e.g. any item whose TTI is not visible at a given time t, gets a TTI value for time stamp t which is the average (perhaps without outliers) of all TTIs in the stack which are visible. A level of confidence parameter may be stored e.g. the level of confidence in a TTI value which is merely an average of other items stacked with this item, is lower than confidence in a TTI value actually read from the item in question.

While it is possible to make collective decisions for all the goods in a given stack—e.g. any item whose TTI is not visible, gets a TTI value which is the average of all TTIs in the stack which are visible, or the TTI value of the closest TTI in its neighborhood, this may be inaccurate, e.g. if one package or item is stuck there for a longer time than others. Thus, use of image processing of the item itself is advantageous to assess its freshness, even if, or especially if, the TTI is not present e.g. due to a coalesced situation. Alternatively, or in addition, stationary sensors may give information on the situation in the station, which may help in ensuring or preventing deviations from norms. Each distributor or customer, in any event, has the ability to look at the individual package TTI or content and check that this item, specifically, is still fresh.

It is appreciated that the TTI of a package atop a stack of multiple packages may experience different e.g. higher or more extreme temperatures. This means that TTI atop a multi-pack or stack or group of coalesced items tends to yield a worst-case scenario for that stack. If external temperature and humidity sensors are available, validity of this paradigm may be assessed accordingly. If the external temperature during transportation is exceedingly low, the external TTI may yield the best-case scenario re remaining shelf-life, as the temperature inside the multi-package is expected to be higher than the outside temperature. Humidity also may play an important role in packages that are not sealed, and thus may be taken in account in assessment.

It is appreciated that according to certain embodiments, an individual item's progress through the supply chain, all the way into Joe's shopping cart, is tracked, typically including indications of periods of time in which the item was coalesced with other items, and the item's successive TTI values, time-stamped and/or location-stamped (e.g. with the location of the camera which read the TTI), are stored in a database.

According to certain embodiments, labelled images of coalesced vs. spread items are provided as a training set which is used to train a classifier to distinguish between coalesced and spread goods.

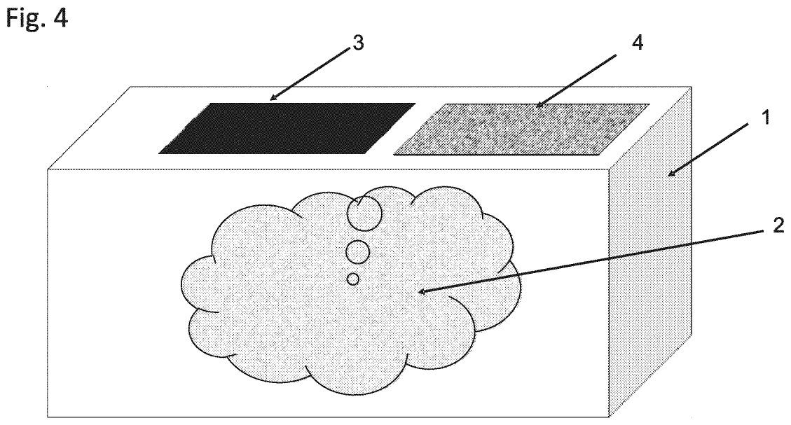

FIG. 4 illustrates an individual package of perishable items with sensing devices attached to it, according to some embodiments of the invention. The package, 1, may optionally be made of substantially transparent material in a way that enables visual inspection of the goods, 2, inside. The individual package, 1, containing the perishable product, 2, may optionally bear on it any one or more of the following: information, 3, in the form of electronic information stored for example in a data logger that is connected to one or more sensors that sample and store data in it, writing, logo, emojis, barcodes, pictures, varying pictures, vocal information, color changing information and the like, as well as sensors, 4, such as gas (such as for example amines and/or thiols and/or CO₂) sensors, time-temperature sensors, threshold temperature sensors, temperature sensors, pH sensors, relative humidity sensors and the like. In some embodiments of the invention, latent and/or visible color tags serve for product (aka item, including perishable goods) authentication, either by the information they provide, or by the information they provide in conjunction with other information, such as GPS (or other) position, bar-coded information and the like.

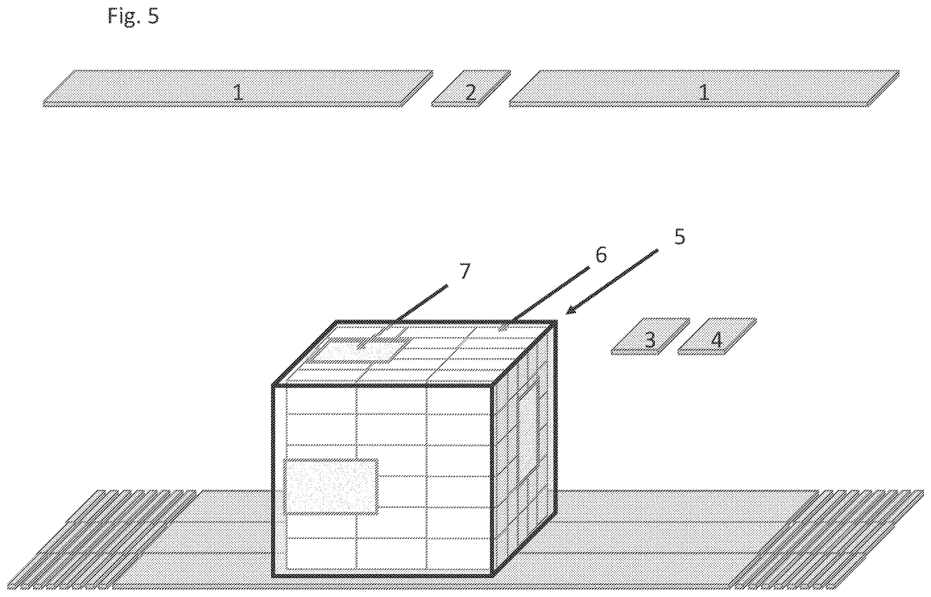

FIG. 5 illustrates one general type of data acquisition station for reading information from the goods and their associated sensing devices of goods in their coalesced state at a node of the supply chain, according to some embodiments of the invention. The system of FIG. 5 includes all or any subset of the following:
1. Product specific and/or general lighting and/or lighting e.g. for exciting emission of latent color from tags on packages, typically for authentication.
2. Computer controlled data acquisition tools, such as cameras, barcode readers, GPS readers, humidity readers
3. Reference color scale
4. Stationary sensors
5. Multi-item package of perishable goods
6. Package unit of perishable goods; and
7. On-package sensors and/or information.

The station may be illuminated, at least some of the time, by product specific and/or general lighting, to facilitate both human and machine vision, as well as optical reading, through the machine vision and optical readers of the data acquisition devices, 2, such as for example cameras, scanners and/or barcode readers. In some embodiments of the invention, said data acquisition devices contain readers for radiation that are not apparent to the human eye, such as near infrared, NIR, radiation, for detecting latent reflecting color and/or emitting color tags that serve for product authentication. In yet other embodiments of the present invention, authentication is achieved by reading information from bar-codes and/or RF-IDs and/or watermarks and the like.

In yet other embodiments of the invention, GPS signals, and/or time readings are used in conjunction with other information to determine authenticity. Said data acquisition station may also contain a reference color scale, 3, that may be used to correct the retrieved optical information for factors interfering with lighting, as well as for inaccuracies of electromagnetic radiation readers.

In supply chain nodes, such as warehouses, plurality of individual packages, 6, are packed in larger containers, 5, that may be made of material that is substantially transmissible for electromagnetic waves, thus allowing reading information from individual packages. In other embodiments, said container material is characterized by substantially low transmittance to electromagnetic waves, thus not allowing reading information from individual packages. In some embodiments of the present invention said larger container, 5, bears on it any one or more of the following: information, in the form of electronic information stored for example in a data logger that is connected to one or more sensors that sample and store data in it, writing, logo, emojis, barcodes, pictures, varying pictures, vocal information, color changing information and the like, as well as sensors, such as gas (such as for example amines and/or thiols and/or CO₂) sensors, time-temperature sensors, threshold temperature sensors, temperature sensors, pH sensors, relative humidity sensors and the like, 7.

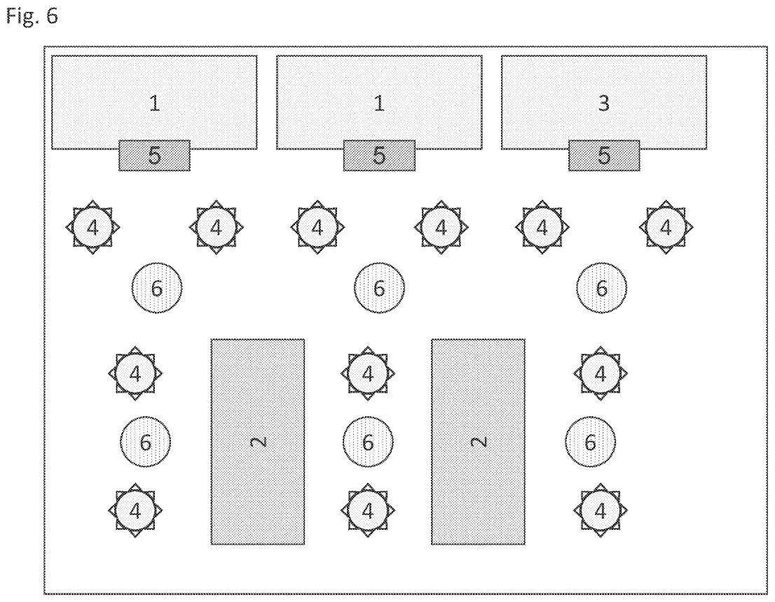

FIG. 6 illustrates one general type of data acquisition station for reading information from the goods and the associated sensing devices of goods in their spread state at a node of the supply chain, according to some embodiments of the invention. The system of the embodiment of FIG. 6 includes all or any subset of the following:
1. Refrigerator containing meat, fish, cheese and alike
2. Shelves bearing vegetables, fruit and alike
3. Refrigerator with composite products
4. Product specific and/or general lighting
5. Reference color scale and stationary sensors
6. Computer controlled data acquisition tools, such as cameras, barcodes, GPS, and humidity readers.

Such spread states of goods may be found for example in stores, where the goods are displayed to customers with the aim of selling them. Yet another example of a spread state of goods, is in the refrigerator of the end user, that stores goods in a relatively small quantity, in an unpacked state. The station may contain one or more storage and/or display items, such as a refrigerator, shelf, and the like. For example, in FIG. 6, 1 is a refrigerator that may for example contain meat and/or fish, and/or cheese and the like; 2 is a shelf bearing vegetables and/or fruits and the like; 3 is a refrigerator containing composite products and/or a mixture of products. It should be understood that the example in the figure merely describes examples of supply chain nodes having perishable goods in their spread state, and other embodiments of the present invention may have different combinations of display and/or storage and/or transportation arrangements.

Nodes characterized by combinations of coalesced and spread arrangements are also possible. The station may be illuminated, at least some of the time, by product specific and/or general lighting, 4, to facilitate both human and machine vision as well as optical reading, through the machine vision and optical readers of the data acquisition devices, 6, such as for example cameras and/or barcode readers. In some embodiments of the invention, said data acquisition devices contain readers for radiation that are not apparent to the human eye, such as near infrared, NIR, radiation, for detecting latent reflecting color and/or emitting color tags that serve for product authentication. For any detection method which does not require light, the station does not necessarily have to be illuminated. In yet other embodiments of the present invention, authentication is achieved by reading information from bar-codes and/or RF-IDs and the like. In yet other embodiments of the invention, GPS signals, and/or time readings, are used in conjunction with other information to determine authenticity. Said data acquisition station may also contain a reference color scale and/or stationary sensors, 5, that are part of the node and do not move along the supply chain with the goods. Said reference color scale may be used to correct the retrieved optical information for factors interfering with lighting, as well as for inaccuracies of electromagnetic radiation readers.

In supply chain nodes, such as stores, a plurality of individual packages may be packed in larger containers that may be made of material that is substantially transmissible for electromagnetic waves, thus allowing reading information from individual packages. In other embodiments, said container material is characterized by substantially low transmittance to electromagnetic waves, thus not allowing reading information from individual packages. In some embodiments of the present invention said larger container bears on it any one or more of the following: information, in the form of writing, logo, emojis, barcodes, pictures, varying pictures, vocal information, color changing information and the like, as well as sensors, such as gas (such as for example amines and/or thiols and/or CO₂) sensors, time-temperature sensors, threshold temperature sensors, temperature sensors, pH sensors, relative humidity sensors and the like.

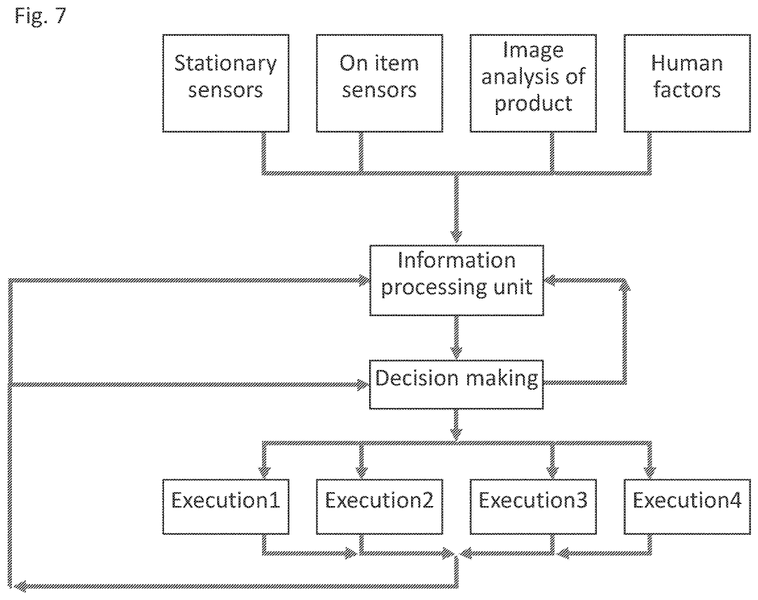

FIG. 7 is a block diagram describing one architecture operative to perform all or any subset of the following: combine and/or process acquired information in the information processing unit, make decisions based on that information, generate commands, to computerized actuators, and/or output requests, to human operators, to execute decisions made, and/or execute decisions made, all according to some embodiments of the invention. Data retrieved from the different information sources at the different nodes of the supply chain may be used for generating a database that allows knowledge-based decision making.

For example, all or any subset of the following functionalities may be provided by a suitably configured hardware processor/s, and the architecture of FIG. 7 may be employed for their implementations:
l. Product identification: the ability to read information from multiple sources, allows the identification of products using information from one or more sources, such as from a scanner, camera-based optical character recognition of written information on a package, or camera-based image recognition of either the product, its package and/or the information appearing on it (barcode, writing, logos and the like).
m. Assessment of remaining shelf-life: identification of the product or product type, in combination with data originating from different sensing units, such as clock, timer, TTIs, TIs, humidity meters, thermometers, light flux meters, camera and the like which may be used for effective assessment of the “freshness condition” of the perishable product. Assessment of data from machine reading the color of the product and/or its appearance, further contributes information that may be used for determining the freshness condition of the products. For example, the curvature of flower stems offers an estimate of their “freshness”. The same holds for the color, shape and texture of fruits, vegetables, meat and fish. Any method described herein for reading or deriving data from TTIs, may be employed.
n. Decision making on controlling the supply chain: A combination of such information gained from imaging devices and other sensors, provides improved ability to make decisions on stocks at any point along the supply chain, providing a better solution than “FIFO” based use of inventory and other decision-making techniques that are based on less information, such as relying only on “best before” dates, or only on TTIs. Such combinations of information allow taking into account factors that are unavailable without such combination of information, for example taking into account extremely low relative humidity conditions that are known to damage the quality of fruits, vegetables, meat and fish, reducing the effective shelf-life relative to the one stated by the “best before” date and even by a TTI, that does not compensate for changes in relative humidity conditions.
   Such decision making may contribute to waste reduction, as, with addition of information, one may reduce safety margins of TTIs, that, being unable to compensate for changing humidity conditions, often must be tailored for a worst-case scenario. This may also serve for waste reduction, increased profit and client satisfaction, as it provides improved means to ensure the quality of the products which are supplied. Likewise, similar information may be used to select suppliers, sub-contractors and outsourced aid, based on their performance, as well as enforcing regulations along the supply chain.
o. Decision making on improvements in the supply chain: Data analysis also indicates the failure points of the supply chain, allowing knowledge-based decision on targeted improvements. For example, out of tolerance humidity and/or temperature conditions may be revealed by local sensors. Yet another way to identify such a problem is through faster or slower than expected progress of TTIs in between two check points or nodes, indicating higher or lower than optimal, or expected or normal temperatures, in between these two check points or supply chain nodes. Any disturbance in client behavior, identified by a camera or purchase rate, may be used for scheduling an inspection of the specific or “offending” section or node or link or portion of the supply chain and/or correction of whatever may be needed e.g. by issuing a suitable warning message.
p. Assessment of client response: collection and analysis of data from purchase points, as well as from around the product stands, e.g. the vicinity of an item of perishable goods, provides valuable information on the current interest and/or demand for the specific product, thus shortening the response time for increasing/diminishing demand for the product, as well as for identifying needed intervention for correcting malfunctions. This data may also assist in identification of purchase patterns of different goods, its time and location dependence and alike. This information may be used for arranging presentation of the goods accordingly.
q. Optimization or adjustment of product price: Combining this with flexible pricing also provides a closed loop for optimizing or modifying the market price for the product, based on or as a function of e.g. learned function of assessment of remaining shelf-life (e.g. via a TTI, which may be read using any method described herein), customer interest in the product according to data obtained from assessment of client response, price and other factors.
r. Using the system to help compliance with different regulations, standards, and laws: The system may be used in order to facilitate and improve compliance with regulations, standards and laws e.g. regarding temperature control, such as refrigeration or heating, by improving data collection, alerting when data indicates breach or near breach of regulation, standard or law, and/or identifying a problematic segment of the supply chain.
s. Any other functionality for management of inventory and/or supply chains for perishable goods, which accepts as an input, an indication of sensor/sensors (e.g. one or more TTI), progress, e.g. between nodes, which is faster (or slower) than expected.

Such sensor/s may be attached to or associated with the product and/or to the station or node or stand.

To determine what is the “expected” progress of TTIs in between two check points or nodes, or rate of progress, the TTI may be calibrated (typically given a required or sensed temperature), yielding a relation between time (expected progress) and TTI color which may comprise a TTI progress calibration graph or table which may be stored in memory, e.g. as described herein.

For example, under certain conditions, including a given refrigeration protocol suited to a particular ambient temperature which is known to have been observed, the expected TTI progress between two nodes a day apart in the supply chain may be a certain amount, and the standard deviation may be determined as well. If the TTI has progressed or deteriorated more than expected, and the deviation is significant relative to the standard deviation, this is suggestive, perhaps, of a failure to adhere to the refrigeration protocol.

Unexpected disturbances in client behavior, which are useful e.g. for supply chain improvement decision making, may be identified by a camera using suitable image processing, and may include abnormal rates of:
customers skipping a specific stand of goods,
customers taking certain goods in hand but refraining from placing in their shopping cart,
customers returning goods from shopping carts to stand.
customers returning specific good from shopping cart and taking other brand, similar product.
   For example, image processing may be used for following or monitoring or tracking all or any subset of:
the position of packages in space and time,
sales rate in payment points,
people density in time at a reference point and around the stand and the like, and purchase rate.

The monitoring may include e.g. counting products sold per unit of time and/or people density in store, date and day of week,

The monitoring may further include comparing to a “norm” database to determine if this data is normal or abnormal, e.g. using pre-computed cut-off criteria to define norms.

Machine learning may be used e.g. to classify customer behavior video sequences as either:
approaching stand, selecting perishable goods, and proceeding to purchase
approaching stand, selecting goods and then returning to stand
approaching stand without selecting goods;
skipping stand,
   e.g. by training a model using a training set of human-labelled video sequences falling within (say) the above categories.

Alternatively, one classification may determine whether or not the customer in the video sequence approached the stand, and/or another classifier may separately determine whether or not the customer placed goods in her or his shopping cart, and/or another classifier may be trained for determining whether goods in the shopping cart were returned or purchased.

Alternatively or in addition, GPS or any other positioning locators may be associated with goods such that location on the stand, of an individual item of perishable goods, then perhaps in the customer's shopping cart, then perhaps back onto the stand having been rejected by the customer, may be recorded.

Identifying items such as shopping carts or perishable goods, may also be achieved by object recognition techniques.

All or any of the above may be used for suitable correction e.g. all or any subset of price change, maintenance, and scheduling inspection of the specific section of the supply chain.

It is appreciated that an individual item's progress through the supply chain, all the way into Joe's shopping cart may be tracked, and its successive time-stamped TTI values may be stored in a database, e.g. if a GPS or any other positioning locator is provided per item. Normally, packages of packed goods carry identification of contents. Thus, the system may either follow the goods as individual packages, or as packed packages. Often, individual item identification is unavailable, but certain use-cases may provide this information, e.g. if a GPS or any other locator is provided per item.

Determination of whether goods are coalesced or not, may rely on the supply chain node or station the goods are located in, since goods which are being packed or transported or stored, tend to be coalesced, whereas goods being offered to buyers e.g. in retail outlets, tend to be spread. Accordingly, different freshness assessment tools or logic or sensors may be used.

The system may determine which freshness assessment tool to use e.g. by determining the dimensions of package for deducing whether the produce is packed in individual packs, or packages of packs. The system may recognize stacks of individual packs e.g. using a trained classifier or other suitable image processing, and may divide number of packs by number of TTIs to determine these dimensions. The system may use plural assessment tools for each identified package, and store the resulting data in a way that retains the origin of the information e.g. the sensor that provided each datum.

A system e.g. cell app and method for reading TTI sensors is now described which is useful both standalone and in conjunction with any of FIGS. 1-7 or any of the above teachings and embodiments, separately or in any combination.

An example TTI is described in the following patent document: http://www.freepatentsonline.com/y2010/0296545.html

However, the teachings herein are suitable to any TTI.

It is appreciated that teachings herein vis a vis TTIs and readings thereof, may also be implemented vis a vis sensor/s other than TTIs.

Embodiments of a SMARTDOT® sensor (aka TTI) reader system, which may or may not be implemented as a cell app, are now described. The methods herein may be applied to other TTIs or sensors which differ from the SMARTDOT® in size, design, graphics, colors, and time/temperature response colors and the SMARTDOT® sensor is referred to herein merely for clarity.

The method of operation includes all or any subset of the processing operations described herein, starting from providing e.g. generating a raw image, such as a cellphone camera image, of the TTI, aka sensor, and eventually generating final user outputs. The method typically employs image filtering and processing techniques to generate an accurate reading, despite variability and uncontrollability of light conditions in which the TTI is imaged.

The system herein typically provides real-time spectra measuring of the exact color of the sensor, which typically employs various tools to correct for changing light conditions and/or to filter for unwanted optical disturbances, such as reflections and shadows. These tools may include ML (Machine Learning) based, image-processing, data fitting, optical calibration tools, and signal/err assessments. Suitable tools that may be used here include, but are not limited to:
Remote barcode scanning and/or
Developed unique interfaces to different platforms.

The method described herein may be applied to any use-case in which it is desired to obtain an exact spectral color measurement e.g. assessing shelf life, agriculture. For example—checking for fruit/vegetable quality and shelf-life, whether the tomatoes are red enough to be picked, etc.
fashion/house design color matching, etc.). Unlike conventional technologies, the method herein typically does not require a dedicated lab spectrometer device, or a static no motion set-up, or carefully controlled light conditions.

To achieve this, all or any subset of the following may be employed:
Utilization of appropriate reference (e.g. the 4 different color areas next to the actual sensor mid circle.
“smart acquisition” e.g. only process images that pass registration validation, and no reflection validation, and avoiding images that typically result with large error.
Adaptive filters.

The utilization of standard smartphone devices, typically in conjunction with a cell app, as opposed to dedicated, high-cost alternative imaging devices, to implement the method herein enables significant cost reduction, since hardware already possessed by end-users is employed, and enables exact color measurements in real-time, real-life environments.

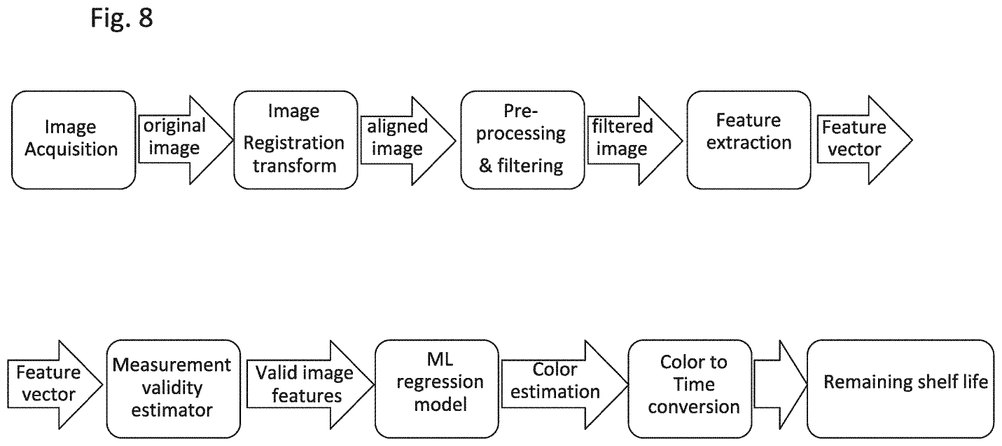

All of any subset of the following operations 1010-1095 may be performed, suitably ordered e.g. as shown in the top-level flowchart illustration of FIG. 8 aka diagram 101:
Operation 1010: acquisition of an image of a TTI
Operation 1020: registration and translation of the TTI image as acquired
Operation 1030: segmentation e.g. of the registered and/or translated TTI image
Operation 1040: pre-processing and/or filtering, e.g. of the segmented image
Operation 1050: extracting features e.g. from pre-processed image
Operation 1060: barcode reading
Operation 1070: measurement validity & accuracy estimators computed and used to reject poor quality images
Operation 1080: ML based regression model
Operation 1090: conversion model converts, say, color measurement to remaining shelf life, or more generally, color change, appearance/disappearance segment, variation in the pattern, shape and/or size of the indication window to time conversion.
Operation 1095: use of system statistical performance evaluation tools

Embodiments of each of the operations are now described in detail (it is appreciated that any suitable operations for fitting image to mask may be employed; those described herein being merely by way of example):

### Image Acquisition Operation 1010:

Image acquisition may be done using a dedicated application e.g. cell app which may support, say, Android and/or Apple's IOS.

The application is typically first used to capture one or more images of a TTI e.g. a sequence of, say, 5 frames, over a time period of, say, from a few tenths of a second to a few seconds.

Image sequence timings may be achieved by utilizing the image capturing mode or the video mode of the smartphone camera, depending on different operating system constraints for different smartphones.

Typically, no color or brightness correction are applied by the application during this operation, as such modifications are already done by the cellphone camera itself. The Images may be captured at any suitable resolution e.g. 512×512, or 1025,1024, or any other resolution which has been verified to generate sufficient detail to enable color measurement accurate enough for the use case, without slowing the processing time to an extent which is unacceptable, given the use case.

The output images are then passed, typically one by one, to the image registration operation of FIG. 8 aka diagram 101.

Image Registration and/or Image Alignment/Translation

For each frame, image registration is performed, to locate the exact position and orientation of the TTI in the image acquired by, say, a smartphone or any other computerized system. Typically, the output of this operation 1020 is an image of the aligned TTI only, whereas the raw image generated by the smartphone camera typically includes the TTI (which is typically unaligned with the image edges) and the TTI's surroundings (e.g. the product or substrate that the TTI has been applied to). In the aligned image, the TTI's straight edges typically coincide with, or at least are parallel, to the image edges, whereas, typically, in the raw image generated by the smartphone camera, the TTI's straight edges typically are neither parallel to, nor coincide with, the image edges.

Once the sensor location and orientation are known, the data is sent to the image alignment (e.g. transformation e.g. translation) process.

### Image Alignment

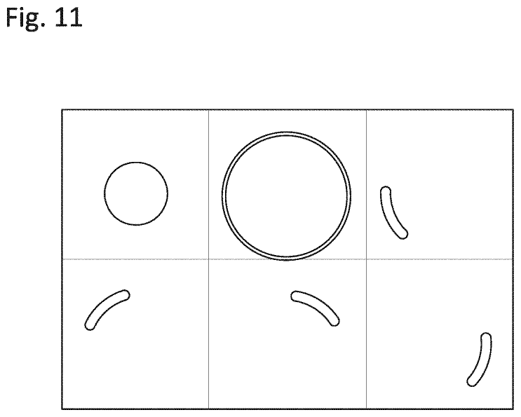

Image perspective transformation (alignment) is applied to the original image in order to extract an image which is exactly aligned with the pre-defined sensor mask image e.g. as shown in FIG. 11 aka diagram 103.

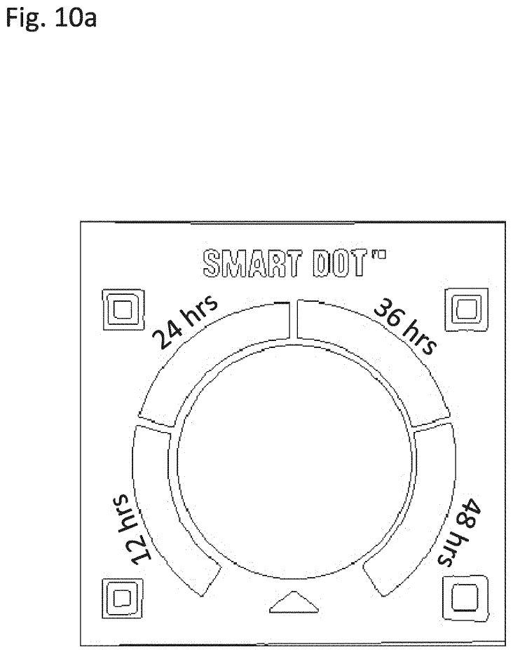

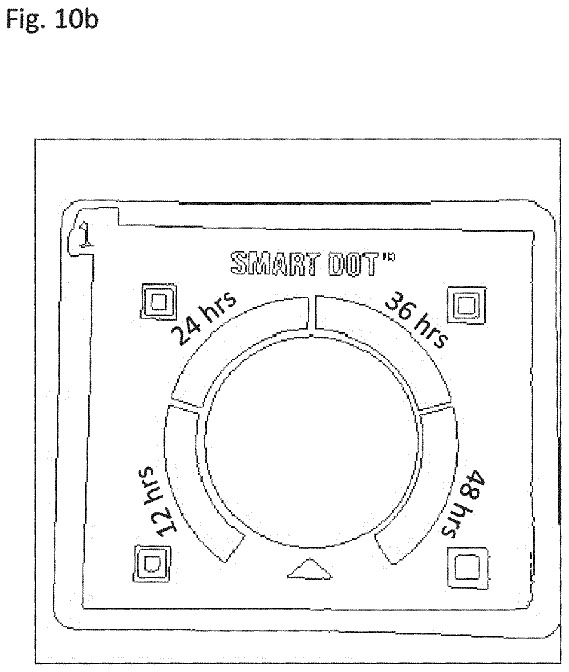

Image registration typically comprises all or any subset of the following operations, suitably ordered e.g. as follows:
A. Transformation of the RGB image generated by the smartphone camera, to a grey scale image using any suitable technology, such as the average method or weighted method described in
https://www.tutorialspoint.com/dip/grayscale_to_rgb_conversion.htm.
B. Validation that certain extracted key connected components appear in the grey scale image e.g. any suitable subset of the connected components described in
https://docs.opencv.org/3.4/d3/dc0/group_imgproc_shape.html
   These key connected components may be used as basic elements for the registration process, if locating these components enables to evaluate the feasibility of the following registration operation.
   If not, processing of the image is stopped and the user gets real-time feedback, indicating that a re-alignment of the camera is required.
   This enables the measurement to be repeated again, if necessary, in real-time.
   If the key components appear, but are not in the right position, this typically indicates that the image is upside down or rotated compared to the pictorial illustration shown for example in FIG. 10a or FIG. 10b.
   In this case, the validation typically also fails. The user gets real-time feedback, indicating that a re-alignment of the camera is required (“no image detected”). Alternatively or in addition, the picture or image may be inverted e.g. using mirroring or mirror-imaging, to handle these cases.
C. Applying a Multiscale-Gaussian-pyramid type registration to the grey scale image.
Running a Multiscale-Gaussian-pyramid type registration algorithm typically comprises applying a process of hierarchal sampling resolution, e.g. a process, as in multiscale_modeling,
in which image processing is re-performed hierarchically, or with increasing sample resolution.

Subjecting an image to repeated subsampling or resampling or down sampling, e.g. in order to subject the image thus sampled to multiresolution analysis, and/or a repeated process of sampling the image, at increasing resolutions respectively, and using the output of this process to compute an optimal transformation per each image sub-section. The process is then repeated, with increasing resolution, eventually yielding a final optimal translation of the whole image e.g. as described in:
https://scikit-image.org/does/dev/auto_examples/transform/plot_prymid.html#sphx-glr-auto-examples-transform-plot-pyramid-py
https://en.wikipedia.org/wiki/Pyramid_(image_processing)
D. Perform transformation of the original image acquired by the smartphone camera, into the same perspective (or coordinates) as the mask image, aka reference image.

The output of this process includes an aligned, transformed image, which is aligned to the mask reference image.

### Image Segmentation

The registered and transformed image which is generated in operation 1020 is typically segmented into specific ROIs (regions of interest) typically using the reference pre-defined masks e.g. apply mask to an image, aka pixel matrix, e.g. including multiplying the 2 pixel matrices.

The ROIs that are selected, typically, respectively, cover various individual operative portions or various subsets of the TTI's operative portions. Thus, the ROIs selected may include all or any subset of:

ROI0: The active portion of the TTI (aka the main ROI aka “indication window” or “active area”, aka “area CC”. In the SMARTDOT® example used for demonstration in this disclosure, the active portion comprises a central portion which may be circular surrounded by plural reference regions which together may form a ring surrounding the circular central portion. In other examples of TTIs the active portion may have different appearance depends in the chosen design and graphics of the TTI.

ROI1-ROI4: Each of plural reference regions aka “reference color segments” aka “reference color legends” aka—O1, O2, O3, O4 respectively, separately. It is appreciated that any number of reference regions may be provided, rather than precisely 4 as in the example, including the option of not having reference colors on the TTI itself, and, if existing, they may appear at any location of the TTI, not necessarily surrounding the active portion. Typically, each reference region bears a color corresponding to the color which the central portion of the TTI assumes after the product on which the TTI is affixed, exhausts a certain portion of its shelf-life. For example, for a product and associated TTI having shelf-life of 48 hours at a pre-designed temperature, if the product and its TTI are kept at the pre-designed temperature, 4 differently colored reference regions may be provided, corresponding to a remaining shelf life of 36 hours (12 hours after activation), 24 hours (24 hours after activation), 12 hours (36 hours after activation), and 0 hours (48 hours after activation), e.g. as shown in FIGS. 10a-10b. If the central region's color most closely resembles the first region, for example, this indicates that the product has a remaining shelf life of up to 36 hours, whereas if the central region's color most closely resembles the third region, this typically indicates that the produce has a remaining shelf life of 12 hours. Typically, the reference regions each comprise an azimuthal portion of a peripheral region e.g. ring surrounding the TTI's active area.

ROI5: A (typically circle or ring-shaped) region including all of O1, O2, O3, O4. Regions ROI0-ROI4 are apparent in the b\w mask image.
an outside external circle aka ce e.g. the top-middle mask in FIG. 11 aka diagram 103, resembling a “thin” ring; this may be used, later, for constructing image luminosity estimators.
in cases where additional barcode information is available, at least one additional barcode ROI (aka ROI6) may be extracted and may be sent to a barcode reader or module which may be used in operation 1050, e.g. as described below.

RO17: includes the active area and bar code, but not the reference regions.

An additional image registration quality estimator may now be derived. Typically, a previous registration quality estimation/validation has been computed, in the course of validating that certain extracted key connected components appear in the gray scale image as described above.

The registration quality parameter may be computed by summing the number of pixels, in the translated b/w or grayscale image generated in operation 1020, whose respective color values differ, to an over-threshold extent, relative to the respective color values of the same pixels in the reference mask image. The “reference mask images” may include all or any subset of the ROI masks which may be added into a single mask (e.g. CC & CE & CO & O1 & O2 & O3 & O4).

For example, if there are 217 pixels (pixel 84, pixel 156, etc.) in the translated b/w or grayscale image generated in operation 1020, whose respective color values differ, to an over-threshold extent, relative to the respective color values of the same pixels (pixel 84, pixel 156, etc.) in the reference mask image, then the registration quality parameter may be 217 or a function thereof, e.g. Est=count (P1xy==P2xy).

This typically comprises an estimator/estimation of what fraction of the BW image was registered successfully. In cases where the registration is valid, the typical values are just below 100%. For non-valid registration, the fraction is typically much lower (˜50%). A suitable threshold of, say, 85% may be chosen as the optimal point, for which the accuracy was maximized.

In cases where the image registration quality estimator/total number of pixels in the image, is less than 85%, the image acquisition process continues, the “bad” image is rejected, and the user gets no positive measurement feedback. The method may then use the next image in the image sequence.

Generally, even if the method fails, the end-user can always simply re-image the sensor or TTI with his cellphone.

It is appreciated that in FIGS. 10a, 10b which are simplified diagrams of a typical TTI, one of the boxes, e.g. the bottom right box may be empty, so as to aid the registration process by creating a set of key feature points that are orientation sensitive, e.g. as described herein in the context of eliminating up-side-down images.

According to certain embodiments, a pre-defined sensor mask may include a set of m images, where n=number of regions of interest in each TTI image, each image i, i=1, . . . m including:

a first group of pixels of a first color e.g. white, which covers an individual (i'th) region of interest, and

a second group of pixels of a second color e.g. black, which covers the entire image other than the i'th region of interest.

Typically, the circle and 2 rings are separated, to accommodate for slight misalignment/imperfect registration, which may result in including pixels from outside of the ROI.

The “thin ring” aka CE ROI, enables assessment of the relative brightness of the sensors' central ROI where a “main” measurement is made (e.g. using the average L*A*B*A component), compared to the (CE) measured ROI, which is used as a luminosity reference (by utilizing the CE bright “white” feature).

### Image Pre-Processing and Filtering Operation 1040

Color System Conversion.—
The original images captured in RGB system, (e.g. if the TTIs being scanned comprise the SMARTDOT® sensors described here: https://apps.apple.com/us/app/smartdot-scan/id1407215149) may be transformed into a L*a*b*color coordinate system e.g. because L*a*b*color mapping allows for a more natural processing of the sensor images, as some of the sensor aging effect is presented in the transition from green to red, which is represented by a single value or color component a* in the L*a*b*color convention, or alternatively by all 3 components or any subset thereof, compared to 3 different values or components in the RGB system. If TTIs with other color changes are used, for example from silver to yellow, another conversion (or no conversion) may be used.

Adaptive Brightness Filtering—
Reflection artifacts (e.g. caused by ambient light conditions and/or by the auto-flash of the smartphone) which may contribute to inaccuracy in determination of the TTI's actual color may be neutralized e.g. by applying, e.g. as described below, a per-pixel, relative brightness filter to each pixel's color values, in the registered translated image generated in operation 1020.
   The adaptive brightness filtering process may be applied selectively, e.g. to only some of the pixels in the registered translated image generated in operation 1020, e.g. by selecting only pixels having brightness within a certain range of values, e.g. only for those pixels whose brightness is between the 20% and 50% percentile of brightness values each of the RIO's in the image. The filter may be applied separately to each of the different elements or regions of interest in the aligned image, e.g. separately to each of the CC, CE, CO, CO1, CO2, CO3, CO4 regions. It is appreciated that example CC, CE, CO1, CO2, CO3, CO4 regions are shown in FIG. 11, in the top-right, top-middle, top-left, bottom-right, bottom-middle and bottom-left images therewithin, respectively. The range of values determining selective filtering, may be computed separately for each region of interest.
   Example: an image brightness filter may be applied to an image of a TTI which includes a bright region, caused by reflection of ambient light, on the right side of the circular active region. These pixels may be removed (e.g. blackened) by the brightness filtering and may not be used for operations 1050 onward. The 20% threshold is an example criterion for removing any pixels with a brightness considerably higher than, say, the median or 50^{th} percentile brightness value of the ROI (as these pixels are more likely to contain reflection artifacts). Removing pixels whose brightness falls within, say, the 20% percentile relative to the median brightness, is done in order to remove any potential shadow effects in the ROI.
   The threshold may be established relative to a median brightness value or any other suitable central value e.g. an average or mode value, where pixels with outlying brightness values may, or may not be used, to establish the central value.
According to certain embodiments, only pixels whose brightness is between 20%-percentile and 50%-percentile of the ROI brightness pixels are used. Example:

Percentile (20%,brightness distribution)>allowed pixel brightness<Percentile (50%,brightness distribution)

### Feature Construction and Selection Operation 1050

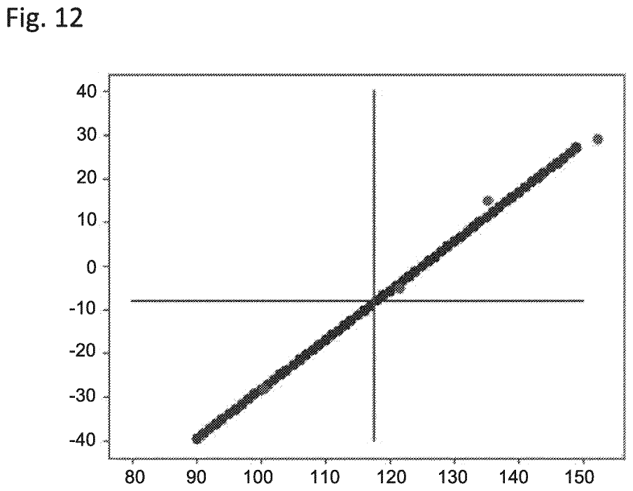

Specific optical features may be computed, which may be designed to characterize the image in a manner which enables accurate color determination, while using as few values as possible. The features may be extracted from (all or any subset of) the center ROI of the image and/or from the reference color legend (e.g. O1, O2, O3, and/or O4) and/or from the external circles (CE and/or CO). The features may include all or any subset of the general and/or higher-level features described below:
General features: For each of one of the ROIs—
Mean, median, standard deviation—For each of, or any subset of, the different (L*, a*, b*) color components.
This standard deviation is computed over a suitable population e.g. over the collection of all the pixels in each specific ROI each time.
For example, the most significant feature may be known to be the a* color component of the CC ROI, e.g. the color of the center circle on the green-to-red scale.
   Higher level features: May include all or any subset of the following:
1. Reference ROI fitted line features:
   Line equation: Y=a*x+b
   Color gradient slope, and elevation
   Intersect of the a* median central value (cc A) on the reference ROI fitted line
   (see horizontal and vertical values in FIG. 12 aka diagram 104)
2. Collection of resampled image L*a*b*components
3. L*a*b*components histogram-based features
For example:
1. Reference ROI fitted line:
   The (linear) relationship is estimated between
      Y: the 4 known reference ROI's L*a*b*component A (pre-measured in the lab using a spectrodensitometer, for each reference component ROI's (CO1, CO2, CO3, CO3), and for each unique sensor type)
   The typical values are: [−28.2, −10.8, 8.9, 29.2]. where these numbers represent each ROI location on the spectrum between green-to-red, in a*=−128→+128 scale)
      X: the 4 measured references ROI's L*a*b*component A (CO1, CO2, CO3, CO3) respectively
   This relationship is modeled using a linear least square fit (e.g. as shown in FIG. 12).
   From this fit, the following are used—
   Line equation: Y=ax+b
   where Y is the “known” L*Aa*b*component a* values of the reference ROI's O1, O2, O3, O4
   and the X represents the “measured” L*a*b*component a* O1, O2, O3, O4 values
   extracting this equation, allows to compute the intersect of the line with the CC L*a*b* a* value (see below).
   Color gradient slope, and elevation (line equation coefficient a, b)
   (these represent the shift and relative change of the theoretical vs the measured values), to be used as independent features
   Intersect of the Aa* median central value (cc a*) on the reference ROI fitted line (see horizontal and vertical values in FIG. 12 aka diagram 104)
The expected known ROI L*a*b*component a* values for (CO1, CO2, CO3, CO3) respectively were measured, using a L*a*b* spectrodensitometer and a commercially available SmartDot® TTI, to be—[−28.2, −10.8, 8.9, 29.2].
   The X vector for the fit shows average ROI a* color component values for (CO1, CO2, CO3, CO3) respectively.
   FIG. 12 aka diagram 104 is a graph showing a result of a linear fit using the “theoretical” a* value against the measured L*a*b*component a* values. The Y axis shows the known reference values, and the X axis shows the measured L*a*b*component a* values, (measured on 1->256 scale).
2. A collection of resampled image L*a*b*components
   The CC RIO may be resampled to, say, 5×5 resolution, and a collection of all pixels' L*, a*, b*
average and standard deviation may be used as a feature vector.
3. L*a*b*components histogram-based features
   A histogram of each of the L*a*b*component may be computed.

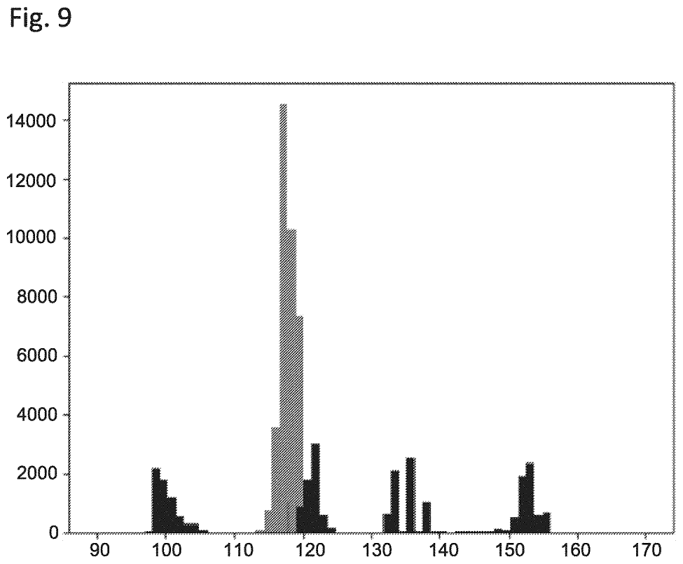

The counts per bin may be used e.g. combined into a vector feature. e.g. as shown in FIG. 9 aka diagram 105 aka diagram ee.

FIG. 9 (aka diagram ee aka diagram 105) is a graph of a histogram representation of the CC a* values (gray) and the O1, O2, O3, O4 ROI's (black) values, used for the fit of FIG. 12 aka diagram 104. The x axis are the measured A color component values or bins, the Y axis shows the number of pixels falling within each “a*” bin.

Typically, the system generates this histogram representation of the image. Typically, the y axis of the histogram is the count of pixels within the value (L*a*b*component A) showing in the X axis. A collection of the Y values above, may be used as an additional feature vector.

### Barcode Reading Operation 1060

In order to track specific item information (such as batch number, manufacture date etc.), an image based barcode reader is implemented. “Imaged based” indicates that the reading is based on the same acquired image, and does not require any additional dedicated hardware, such as conventional laser-based scanners.

The app may include barcode reader functionality, or may interface via a suitable API with a barcode reader app such as “QR & Barcode Scanner”.

The barcode reading may be implemented using an open-code image processing library, so as not to require any API interfaces.

The barcode ROI (aka ROI6), as segmented in operation 0130, may be transferred to the image barcode reading module, which typically comprises an algorithm component (lib) used for implementing the barcode reading. In this module, the barcode image may be read and converted to alphanumeric characters e.g. text.

The barcode decoding may use a suitable barcode decoding library e.g. the Zbar c++ dedicated Python barcode decoding library, such as a Zbar.

### Measurement Validity Estimation Operation 1070

Additional estimator features may also be constructed and computed in order to estimate the measurement accuracy and validity. These measurement validity estimators may also be used as input to the ML prediction model computation itself or may be used to reject images with poor quality, which may result in inaccurate predictions.

If an image is “rejected”—typically the app prompts the end-user to image again, or take another measurement. Typically, the user does not receive any measurement reading, and may instead receive a “reflection detected” error indicating that the image position needs to be changed to avoid any direct reflections of light sources.

The estimator features computed in operation 1070 may include all or any subset of the following:
Reflection ratio estimator, designed to quantify a degree of reflection, or reflection condition, of the image. The estimator may be computed by dividing the center ROI relative brightness standard deviation. By the average e.g.—

Reflection Ratio=standard deviation (center ROI−‘L’ values)/average (center ROI−‘L’ values).
This standard deviation and average may be computed over the distribution of pixels inside the cc ROI.
   The output values of this reflection ratio are usually in the range of 0 to 1.0.
Reflection ratio values above 0.5 indicate that the relative brightness standard deviation is over 50%, e.g. due to significant reflection in the central region of interest. Since many or most of these images may result in an inaccurate measurement, images with high reflection ratio values, e.g. over 0.5, are rejected.
i. typically, for reflection the userfeedback is—“reflection detected”
For registration invalid—userfeedback is “no image detected”
Relative luminosity estimator which may be computed by comparing the average brightness (or other central tendency of pixel brightness, with or without outliers) of all pixels in the central ROI (CC) relative to the average (e.g.) brightness of all pixels in the external circle ROI (CE) e.g.

Luminosity estimator=average (CC ROI−‘L’ values)/average (CO ROI−‘L’ values).
The output values of this relative luminosity estimator are usually in the range of 0 to 1.0. since the external white circle is usually brighter than the central ROI CC, except for cases with significant direct reflection. A cutoff value of, say, 0.5 is applied, to select only images with luminosity estimator of below 0.5. If the estimator is higher, the user is notified and “image invalid” feedback is returned; the user is invited to acquire another image of the TTI.
Typically, the current user feedback is the same for rejections due to any of the reasons described above. Typically, e.g. in this case, the measurement is continued until the processing is successful (e.g. the image passed all validity checks). Once a valid image is processed, the feedback is displayed as the measured value on the screen.
   This feedback may also be extended to give additional information such as an indication of the potential cause of the problem. (e.g. registration issues/reflection issues, insufficient/excessive luminosity issues).
Measured “a*” standard deviation: based on the standard deviation of the central ROI (CC) ‘a*’ color values. Since the ability to accurately evaluate the average “a*” color component values in the middle circle or active area is typically correlated to the ability to generate successful system outputs, the standard deviation of the “a*” color component values in the middle circle gives a good estimate of the expected accuracy of the average e.g.:

a*std=standard deviation (CC ROI−‘A’ values)/average (CO ROI−a*’ values).
The typical values for this estimator are usually in the range of 0 to 10%. A suitable cutoff value of, say, below 2.5% is applied, to select only images with consistent inner color. Images above the selected cutoff may be rejected; typically, the user is then notified, and “image invalid” feedback is returned; the user may be invited to acquire another image of the TTI.
Image sharpness estimator: An estimate of the sharpness/blurriness of each image of the TTI may be operationalized using any suitable method, e.g. as described herein: https://www.pyimagesearch.com/2015/09/07/blur-detection-with-opencv/. For example, sharpness may be estimated, say using OpenCV, Python, and the Laplacian operator, by computing the variance of the image's Laplacian which may be represented using a suitable Laplacian kernel, e.g. by: convolving a single channel of the TTI (grayscale e.g.) image with the following
3×3 kernel:
0 1 0
1 −4 1
0 1 0
and computing the variance (squaring the standard deviation) of the response. If the variance falls below a pre-defined threshold, the image may be considered blurry; otherwise, the image may be considered sharp.
Any suitable pretesting may be performed to generate this threshold. For example, the pre-defined threshold may be set by statistical evaluation of the image accuracy vs. the variance. A trade-off may be implemented between rejection probability, and average resulting increase in accuracy.

### Operation 1080: Apply Color-Predicting KNN Regression Model to Features

K nearest neighbors is an algorithm operative to store all available cases and predict a numerical target based on a similarity measure (e.g., distance functions).

All or any subset of the features which were constructed in operations 1050 and/or 1070 may be combined in to (typically a single) feature vector, which may be used as an input for the regression model. The regression model applied may be based on the K-Nearest neighbor regression model algorithm (KNN), e.g. as described here:

https://docs.opencv.org/2.4/module s/ml/doc/k_nearest_neighbors.html
https://scikit-learn.org/stable/modules/generated/sklearn.neighbors.KNeighborsRegressor.html
The KNN regression model process typically includes 2 phases or operations e.g. training and prediction.

It is appreciated that other models may be used as alternatives to the KNN regression model referred to herein by way of example.

Any suitable data may be used to train the KNN model. For example, a suitable data collection process may include the following operations a and/or b:

a. Parameterize Calibration

Generate a calibration graph or functionality to convert the color measurement (expressed e.g. as L*a*b*values) to remaining shelf life (RSL). To form the graph, a dedicated instrument (e.g. spectrodensitometer) may be used to determine the sensors' actual color change during the whole shelf life, using a suitable uniform sensors testing protocol throughout. The sensors change color during the reaction and each color represents a certain different RSL. Also, the reflection of the sensor changes during the reaction and the sensor RSL may be determined even with the reflection. Once the calibration graph has been created, the cell app or reading system described herein uses this graph or functionality to convert measured color into RSL.

b. Creating Data Base in Various Conditions

Collect data in different conditions. For example, each sensor may be marked with a unique number or identifier and measured or read, first with, say, a spectrodensitometer, color meter or other suitable device, to determine its real color, and then in different conditions with the TTI reader or cell application described herein. For the ML or machine learning process, measure the sensors under different lighting conditions (yellow, white, shade, sunlight, hot and cold light), at different photography angles, on different surfaces, and any other parameter which may affect color read by the camera. The true color values for each sensor are known, allowing results to be analyzed for each sensors' unique conditions. If there is a misfit due to a certain condition between the true color and the result obtained from the app, the algorithm typically learns to determine the real color. This eventually yields a database that contains a variety of conditions and information and may be used worldwide to determine color, and thus RLS's, of sensors.

It is appreciated that the flow of FIG. 8 illustrates the real time operation e.g. when an end-user uses the cell app, thus training which is done offline is not shown in FIG. 8.

Offline operations preceding the method of FIG. 8, other than collecting data and training a model on that data, may include generating a calibration curve or table that relates the color (“a*” value) to the remaining sensor lifetime e.g. as described herein.

Then, a cell app is provided which is able to perform the operation of FIG. 8, and typically incorporates the model and the curve, and the cell app is uploaded to a suitable app store. TTI-marked produce is deployed, and end-users download the cell app.

According to certain embodiments, the only “free” parameter that is received by the knn is the number of knn nearest neighbors to use. That performance of model with different values may be set to, say, KNN=10, and the value may be re-optimized for use with different sizes of training sets

### Operation 1. Model Training—

As part of the development of the system, the application may be used to capture sensor in different known exposure conditions e.g. as per the data collection process described herein in the context of FIGS. 8-12.

These image sets may be used to extract the feature vector per each image e.g. by first capturing images of the tested sensors using the app, and then repeating operations 1010 to 1070 for each image. These extracted feature vectors may be stored as a training set for the model.

In the training stage—a set of such feature vectors together with the known reference measurements values (the ‘train set’) may be used as an input for the model fitting.

The X values for the model typically comprises a matrix containing the collection of feature vector for each image, e.g.

V={f1,f2,f3,f4,f5 . . . }

X={(v1,L*a*b*reference value 1),(v2,L*a*b*reference value 2),(v3,L*a*b*reference value 3),(v4,L*a*b*reference value 4), . . . }

Trained model=KNN_FIT(X,Y)

This process generates a “pre-trained” regression model which is stored as an .xml file, typically in memory accessible to the cell app.

Typically, the model is re-trained every time there are new images available that may be used and incorporated into the model. Typically, the model is not trained with every image that is taken by a client, but only with images taken in the laboratory followed by their real parameters optical testing.

In order to enable quick load time, the model may be pre-loaded when the application is operating, and not retrained per each use.

An example procedure for training a KNN classification model or KNN regression model, is described in: https://www.ritchieng.com/machine-learning-k-nearest-neighbors-knn/

### Operation 2. Model Predictions

The pre-trained KNN model, is loaded into the application and is now applied to the new image by:
Applying the image processing operations 1010-1070 e.g. as described above. Extracting the new image feature vector e.g. by performing operations 1010→1070.
Finding the N images in the training set, which have the most similar feature vectors (nearest neighbors) using a Euclidean distance estimator.
Input to the KNN model consists of the k training examples which are “closest to” the current TTI that are being read.
k-nearest neighbors algorithm (k-NN) output In k-NN regression, the property value for the object typically comprises a central tendency e.g. average of the values of k nearest neighbors. It is appreciated that the regression model is typically operative to predict a continuous rather than discrete value.
The neighbors are taken from a set of objects for which the object property value is known. This may be considered the training set for the algorithm or model. Operation 1080 may assign weights to the contributions of the neighbors (e.g. some descending function of d, the distance from the current data point to the neighbor, to ensure that nearer neighbors contribute more to the average of the values of k nearest neighbors than less near neighbors do, e.g. weight (neighbor at distance d)=1/d.
Computing the (typically weighted) average of the expectation value over the N nearest neighbors.
   This average result is the model's prediction for the sensor color value for the image acquired in operation 1010 e.g. per each of the valid input frames

### Frame Merge—

After applying the prediction model to each of the plural valid input frames e.g. is applied to the 5 initial frames acquired, yielding plural measurements, the plural measurements are merged into a single prediction e.g. by:
Removing any invalid images (e.g. images that were rejected or did not pass all or any subset of the validity checks described herein)
Removing outlier frames which are more than (say) 1.5 standard deviations away from the average “A*” color component value of all remaining frames (all valid frames).
Recomputing of the average value of “A”, without outlier frames.

### Color to Remaining Shelf-Life Conversion

For each sensor type, a calibration curve that relates the color (“a*” value or other color parameters and/or colour measuring method which represents the TTI color change) to the remaining sensor lifetime at a certain temperature may be stored in the system. This calibration curve may then be used in order to perform the final conversion of the model output “a*” (e.g. the average value of “a*”, without outlier frames) to a result indicative of remaining shelf-life estimation. These results may then be fixed or transformed to be in the relevant measurement range. For example, any result with negative t may be transformed to t=0, and/or results with t>max, may be transformed to t=max (where max may be, in the above-illustrated example, 48 hours).
The transformed value is, typically, what is presented to the end-user e.g. displayed on the application screen.
Operation 1095: Using System statistical performance evaluation tools for monitoring of the system performance, and/or re-training the model, by updating and training set e.g. by acquiring or selecting new images to be used as a training set in the future.

The model may be retrained from time to time e.g. after each experiment is done or, say, every few weeks. Each image processed by the application may be transferred and stored remotely, together with results derived from each such image e.g. the final results presented to the end-user by the cell app, responsive to the end user's having acquired that image. This enables constant monitoring of the system performance, and/or acquiring new images to be used as a training set in the future. Remote storage may be achieved e.g. using a cloud service such as Amazon's AWS cloud services. Using the laboratory tests data sets, enables monitoring the accuracy of the application over multiple number of images.

All or any subset of the following accuracy estimators, or similar, may be used—

N3: The % of images

for which the measurement error was below 3 hours.

Typically, the N3% is used to estimate performance over the TEST dataset; this usually correspond to the last lab test measurement. Training of the model may be repeated or updated periodically; the train test used may comprise a dataset with reference measurements from previous lab tests.

Measurement error may, for example, comprise a difference in units of [hour] between shelf life as measured, and the known shelf life.

N4.5: The % of images for which the measurement error was below 4.5 hours.

N7: The % of images for which the measurement error was below 6 hours.

STD err: The standard deviation of the difference between the predicted remaining shelf-life given by the app, and the real measurement of the same product's remaining shelf-life deduced from the true color measurements done by spectrodensitometer)

All the above statistics may be computed for each new lab test, and the performance may be compared relative to models trained on different/previous data, or to different data when evaluating a new model.

lva_a,lva_b: Coefficients of a linear least square fit of the lab vs application (lva) results e.g. as shown in the graph of FIG. 12 aka diagram 106.

FIG. 12 aka diagram 106 is an example of system accuracy evaluation showing graphed lab vs. application (lva) results and a linear least square fit to those results. In FIG. 9 aka diagram 106, the X axis shows the “a*” color component values as measured in the laboratory.

The Y axis shows remaining shelf-life predictions or the “a*” color component values or predictions generated by the application.

The diagonal line is a 45 degree line that goes through the 0,0 point, and is displayed as a reference to an “ideal” measurement.

The graph may use the A component in the L*a*b* coordinate system. e.g. for values between −30 through 30.

Optionally, a few iterations of the above training of the app may be performed, until satisfactory accuracy is achieved. This iteration model may include estimating the effect of using a subset of a previously done lab calibration. In each iteration or each step in the iteration, a subset of the dataset is typically added or removed, e.g. based on the change in accuracy of the model test results.

It is appreciated that many variations fall within the scope of the invention.

For example:

Either binary or multistep sensors may be provided. Any suitable states may be provided, in each. For example, a 3-step TTI sensor may have 3 states such as dark gray, light gray and disappearance. The states need not vary necessary in terms of color and may alternatively or in addition vary in terms of the actual pattern or shape and/or its size. For example, a large indication window may correspond to a less fresh product as opposed to a small indication window which may correspond to a fresher product. According to some embodiments, there is a disappearing portion of the indication window which disappears under certain circumstances such as when the product is no longer fresh. The product may be marked suitably e.g., if the portion of the indication window which disappears is leaf-shaped, “Best if used before leaf disappears”.

Alternatively or in addition, changes may be provided in the size of the indication window, this being one possible parameter that the system can identify and convert into relevant output parameters such as but not limited to estimated remaining product life time and/or a binary indication of whether the product is currently fit for purchase.

Alternatively or in addition, a dynamic reference color may be provided, such as, for example, a portion of a sensor (e.g. TTI) which changes color quickly and then serves as a reference to which the color/s of other portion/s of the sensor which may change color more slowly, may be compared. For example, a sensor may initially have a certain color such as, say, green. Then one portion of the sensor (say the left half of a circular indication window) may turn red. Then as the product becomes less fresh, the other portion of the sensor (say the right half of the circular indication window) may slowly turn red. This provides online calibration since in analysis, the changing color of the right half, which is indicative of the product state, may be compared to the left half, for reference, thereby facilitating the determination of whether or not the product has expired.

It is appreciated that plural portions of an indication window may be associated with plural time-windows respectively. For example, one portion of the indication window may be used to indicate the suitability of the product for use within 3-7 days whereas another portion of the indication window may be used to indicate the suitability of the product for use within 0-3 days. Once the product is only suited for consumption within 3 days or less, the portion of the indication window corresponding to the 3-7 days time window may have entirely disappeared, whereas the color level of the portion of the indication window corresponding to the 0-3 day time window may still be visible.

Alternatively or in addition, plural indication windows may be provided e.g. in order to provide indications of plural respective life times, each intended for a different end-user e.g. a government inspector end-user, a retailer end-user, a customer (of the retailer) end-user, etc. this may be used to provide, say, different resolutions for different categories of end-users. For example, the customer may be interested in a resolution of days whereas a wholesaler end-user may be interested in a resolution of weeks.

It is appreciated that the ΔE parameter may be employed for CIE ΔE color changes, alternatively or in addition to other parameters described herein.

The TTI may be read directly, or may be read indirectly e.g. through a mirror or mirror system including plural optical elements, which direct/s the image to a specific camera configured to read and recognize the TTI.

Plural applications may be combined, to yield a life time signal and/or any other output parameter described herein. For example, a combination of RF and TTI may be employed; RF signals combined with inputs from a TTI may be used to provide, say, a lifespan indication or any other output parameter shown and described herein.

Alternatively or in addition, any embodiment herein may be combined with any known substrate for packaging perishable goods or any application onto any substrate for packaging perishable goods or any method for determining quality of such goods e.g. as shown and described in co-owned U.S. Pat. No. 7,081,364.

It is appreciated that the applicability of the embodiments shown and described herein is not limited to food products and is also suitable for non-food products, such as but not limited to cosmetics, medicines, vaccines and toothbrushes, or any other product which may bear a TTI.

The operations herein are described, merely by way of example and for simplicity, in terms of example resource libraries and software tools such as NumPy (Python programming language's numerical mathematics extension), OpenCV (Open source library of programming functions for real-time computer vision), sklearn, and matplotlib (plotting library for the Python programming language and NumPy including an object-oriented API for embedding plots into applications). It is appreciated that alternatively, any other implementations of the operations herein may be employed.

It is appreciated that terminology such as “mandatory”, “required”, “need” and “must” refer to implementation choices made within the context of a particular implementation or application described herewithin for clarity, and are not intended to be limiting, since in an alternative implementation, the same elements might be defined as not mandatory, and not required, or might even be eliminated altogether.

Components described herein as software may, alternatively, be implemented wholly or partly in hardware and/or firmware, if desired, using conventional techniques, and vice-versa. Each module or component or processor may be centralized in a single-physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order including simultaneous performance of suitable groups of operations as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

The system may, if desired, be implemented as a network e.g. web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Any or all functionalities e.g. software functionalities shown and described herein may be deployed in a cloud environment. Clients, e.g. mobile communication devices such as smartphones, may be operatively associated with, but external to, the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false, and to perform y each time x is determined to be true, thereby to yield a processor which performs y at least once, typically on an “if and only if” basis e.g. triggered only by determinations that x is true and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein to have capabilities to perform a technical operation responsive to the state or condition. The technical operation may, for example, comprise changing the state or condition, or may more generally cause any outcome which is technically advantageous given the state or condition or data, and/or may prevent at least one outcome which is disadvantageous given the state or condition or data. Alternatively, or in addition, an alert may be provided to an appropriate human operator or to an appropriate external system.

Features of the present invention, including operations, which are described in the context of separate embodiments, may also be provided in combination in a single embodiment. Features may also be combined with features known in the art and particularly, although not limited to, those described in the Background section, or in publications mentioned therein. It is appreciated that any features, properties, logic, modules, blocks, operations or functionalities described herein which are, for clarity, described in the context of separate embodiments, may also be provided in combination in a single embodiment except where the specification or general knowledge specifically indicates that certain teachings are mutually contradictory and cannot be combined. Any of the systems shown and described herein may be used to implement or may be combined with, any of the operations or methods shown and described herein.

Conversely, any modules, blocks, hardware components, operations or functionalities described herein, which are, for brevity, described in the context of a single embodiment, may also be provided separately or in any suitable sub-combination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered e.g. as illustrated or described herein.

Devices, apparatus or systems shown coupled in any of the drawings may in fact be integrated into a single platform in certain embodiments, or may be coupled via any appropriate wired or wireless coupling such as but not limited to optical fiber, Ethernet, Wireless LAN, Radio communication, HomePNA, power line communication, cell phone, VR application, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation, and is not intended to be limiting.

Any suitable communication may be employed between separate units herein e.g. wired data communication and/or in short-range radio communication with sensors such as cameras e.g. via WiFi, Bluetooth or Zigbee.

It is appreciated that implementation via a cellular app as described herein is but an example, and, instead, embodiments of the present invention may be implemented, say, as a smartphone SDK, as a hardware component, as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile e.g. Laptop or other computer terminal, embedded remote unit, which may either be networked itself (may itself be a node in a conventional communication network e.g.) or may be conventionally tethered to a networked device (to a device which is a node in a conventional communication network or is tethered directly or indirectly/ultimately to such a node).

Any operation or functionality or computation or logic described herein may be implemented entirely or in any part on any suitable circuitry including any such computer microprocessor/s as well as in firmware or in hardware or any combination thereof.

Any operation or characteristic described herein may or may not actually be performed or provided, and the description is intended to include apparatus whether hardware, firmware or software which is configured to perform, enable or facilitate that operation or to enable, facilitate or provide that characteristic.

It is appreciated that elements illustrated in more than one drawings, and/or elements in the written description may still be combined into a single embodiment, except if otherwise specifically clarified herewithin. It is appreciated that any features, properties, logic, modules, blocks, operations or functionalities described herein which are, for clarity, described in the context of separate embodiments, may also be provided in combination in a single embodiment except where the specification or general knowledge specifically indicates that certain teachings are mutually contradictory and cannot be combined. Any of the systems shown and described herein may be used to implement or may be combined with, any of the operations or methods shown and described herein.

1-35. (canceled)

36. A method for management of perishable goods handling, including using a hardware processor for reading and/or recognition and/or monitoring at least one of color change, appearance/disappearance of at least a segment, variation in at least one of pattern, shape and/or size of at least a portion of an indication window of at least one TTI affixed to at least one item of perishable goods, thereby to obtain a TTI reading, and for processing said reading including generating and outputting at least one perishable goods handling command, responsive to at least said TTI reading.

37. The method of claim 36 wherein said handling comprises management of a perishable goods supply chain.

38. The method of claim 37 and wherein at least one command comprises scheduling an inspection of a suspect portion of the supply chain and/or issuing a warning message.

39. The method of claim 37 wherein said method comprises storing knowledge regarding expected progress of TTIs between supply chain nodes, monitoring actual progress of TTIs between supply chain nodes and wherein at least one command is issued when said actual progress is faster or slower than said expected progress.

40. The method of claim 38 wherein said suspect portion is identified at least partly by monitoring TTI readings associated with said supply chain portion (node/s and/or link/s).

41. The method of claim 36 wherein outputting of at least one perishable goods handling command, is responsive also to data other than said TTI reading and wherein said data comprises location of acquired data (e.g. GPS).

42. The method of claim 38 wherein said suspect portion is identified at least partly by monitoring human behavior associated with said supply chain portion (node/s and/or link/s).

43. The method of claim 36 wherein said reading comprises pre-processing and/or filtering of a segmented image of said TTI.

44. The method of claim 36 wherein said reading comprises extracting at least one feature from image data derived from said TTI and using a Machine-learning based model which receives said at least one feature as input.

45. The method of claim 36 wherein said TTI readings typically have reduced safety margins which do not compensate for at least one ambient condition known to fluctuate and wherein said ambient condition is measured directly, thereby to yield at least one direct ambient condition measurement and wherein at least one command is issued responsive to said TTI readings and to said at least one direct measurement.

46. The method of claim 44 wherein said model comprises a knn regression model.

47. A computer program product, comprising a non-transitory tangible computer readable medium having computer readable program code embodied therein, said computer readable program code adapted to be executed to implement a method for management of perishable goods handling, including using a hardware processor for reading at least one TTI affixed to at least one item of perishable goods, thereby to obtain a TTI reading, and for outputting at least one perishable goods handling command, responsive to at least said TTI reading.

48. The method of claim 36 and also comprising using Measurement validity & accuracy estimators to reject poor quality images of said TTI.

49. The method of claim 36 and wherein a conversion model converts color measurement derived from said TTI, to remaining shelf life or any other parameter or alert such as a binary indication of whether or not produce is good for use, at a given temperature.

50. The method of claim 36 wherein said method includes validating that at least one key connected component appears in an image of the TTI and otherwise, providing a command, in at least near real-time, to re-align a camera thereby to allow imaging of the TTI to be repeated timely, when necessary.

51. The method of claim 36 wherein said handling comprises control of perishable goods inventory and wherein said at least one command typically includes at least one command to use certain perishable goods items in an order other than FIFO order.

52. A system for management of a perishable goods supply chain which comprises plural nodes, the system including using a hardware processor for reading at least one sensor affixed to at least one item of perishable goods and/or to at least one of the plural nodes, wherein said system is operative to provide all or any subset of the following functionalities:
a. Product identification;
b. Assessment of remaining shelf life;
c. Decision making on controlling the supply chain;
d. Decision making on improvements in the supply chain;
e. Assessment of client response;
f. Optimization or adjustment of product price;
g. Facilitating compliance with regulations, standards, and laws;
h. management of inventory and/or supply chains for perishable goods, based at least on determining whether TTI progress between supply chain nodes is faster or slower than expected or as expected
i. enabling decision making
j. raising flags
k. generating recommendations.

53. The system of claim 52 wherein a reading of at least one sensor on at least one stand or node or item of perishable goods contributes to the ‘system's knowledge of the supply chain's state and wherein at least one decision made by the method is based on said knowledge.

54. The method of claim 37 wherein said reading comprises machine-reading.

55. The system of claim 52 wherein said at least one sensor includes at least one stationary sensor and at least one mobile sensor.

56. The system of claim 53 which is configured for capturing human behavior and wherein analysis of the human behavior as captured also contributes to the method's knowledge of the supply chain's state.

57. The method of claim 36 wherein the TTI is imaged more than once thereby to generate plural TTI images and wherein knowledge derived by combining said images is used to make at least one decision.
